(19) United States
(12) Patent Application Publication
(10) Pub. No.: US 2025/0092532 A1
(43) Pub. Date: Mar. 20, 2025

(54) HYDROGEN PRODUCTION FROM AIR

(71) Applicant: THE UNIVERSITY OF MELBOURNE, Melbourne (AU)

(72) Inventors: Gang LI, Melbourne (AU); Jining GUO, Melbourne (AU)

(21) Appl. No.: 18/577,003

(22) PCT Filed: Jun. 30, 2022
(86) PCT No.: PCT/AU2022/050675

§ 371 Date: Jan. 5, 2024

(30) Foreign Application Priority Data
Jul. 8, 2021 (AU) 2021902082

(51) Int. Cl. C25B 1/04; B01D 53/14; B01D 53/18; B01D 53/26; B01D 53/28; C25B 11/03; C25B 11/042; C25B 13/02; C25B 13/05; C25B 15/08

(52) U.S. Cl. CPC C25B 1/04; B01D 53/1493; B01D 53/18; B01D 53/263; B01D 53/28; C25B 11/03; C25B 11/042; C25B 13/02; C25B 13/05; C25B 15/08; B01D 2252/30; B01D 2257/80; B01D 2258/06

(57) ABSTRACT

A process of producing hydrogen from air comprising: contacting a hygroscopic liquid with a source of air to absorb a water content from said source of air into the hygroscopic liquid; and electrolytically converting the water absorbed in the hygroscopic liquid into hydrogen and oxygen.

### PRIORITY CROSS-REFERENCE

The present invention claims priority from Australian provisional patent application No. 2021902082 filed 8 Jul. 2021, the contents of which should be understood to be incorporated into this specification by this reference.

### TECHNICAL FIELD

The present invention generally relates an apparatus and process of producing hydrogen directly from air. The invention is particularly applicable to the generation of green hydrogen using solar electricity and it will be convenient to hereinafter disclose the invention in relation to that exemplary application. However, it should be understood that the process and apparatus could be applied to various electricity sources to produce hydrogen.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Hydrogen (H₂) is the ultimate clean energy. H₂ produced by water electrolysis using renewable energy namely, the green hydrogen, represents the most promising energy carrier of the low-carbon economy. H₂ can also be used as a medium of energy storage for intermittent energies such as solar, wind, and tidal.

However, clean water can also be a scarce commodity. Direct water electrolysis can intensify demands for clean water and consequently increase the global risk of freshwater shortage. The water purification process also adds complexity and costs to the H₂ production, leading to feasibility risks for industrial implementation. The geographic mismatch between renewable electricity availability and freshwater accessibility adds even more challenges to green H₂ production. Taking solar energy as an example, locations exposed to high solar photovoltaic energy usually have limited freshwater resources. Therefore, obtaining reliable clean water source for green H₂ production remains a challenge in these geographical locations.

Direct saline water splitting has previously been trialed. However, most processes have significant challenges such as electrode fouling by salt precipitates and microbial deposit, as well as side production of chlorine.

Similarly, solar power water splitting has also been trialed, for example as taught in Kölbach et al, Efficiency gains for thermally coupled solar hydrogen production in extreme cold, Energy Environ. Sci. (2021) DOI: 10.1039/d1ee00650a. However, such systems still require a clean water supply to feed into the water splitting device.

Water vapour can potentially provide a suitable water source due to its consistent availability and natural inexhaustibility. Several researchers have reported electrolysers using inert gases as a humidity carrier in the feedstock instead of a real atmospheric gas mixture. However, high inert gas flow and humidity are required to provide the essential driving force and mass transfer rate for water electrolysis. Therefore, the ratio of end product only contains less than 5% H₂, and the utilization of such dilute H₂ is extremely difficult, requiring an efficient gas separation process.

It would therefore be desirable to provide an alternate process and associated apparatus for producing hydrogen.

### SUMMARY OF THE INVENTION

The present invention provides a new apparatus and process of producing and collecting hydrogen, preferably high purity hydrogen, by water electrolysis without consuming freshwater resources.

A first aspect of the present invention provides a process of producing hydrogen from air comprising:
contacting a hygroscopic liquid with a source of air to absorb a water content from said source of air into the hygroscopic liquid (absorption step); and
electrolytically converting the water absorbed in the hygroscopic liquid into hydrogen and oxygen (electrolysis step).

The present invention therefore provides a hydrogen production process which captures water from air, preferably atmospheric air, and converts it to hydrogen by electrolysis. The only energy input into the system is electrical energy, preferably provided by renewable energy. Harvesting water from air utilises an alternate water source separate to fresh water sources, allowing the process and associate apparatus to harvest fresh water for electrolysis decoupled from geographic limitations of the world's freshwater resources. Hydrogen can therefore be generated anywhere where the air contains a suitable amount of moisture.

Water absorption is achieved in the process using a hygroscopic liquid. Hygroscopic substances can attract and hold water vapour from the air and in many instances can potentially capture moisture at a very low relative humidity, such as less than 20% RH—for example a R.H. of as low as 4%. A variety of hygroscopic substances can be used for the hygroscopic liquid. In many embodiments, the hygroscopic liquid comprises an ionic liquid or a hygroscopic ionic solution. Examples of ionic liquids include imidazolium based ionic liquids such as 1-ethyl-3-methyl imidazolium ethyl sulfate (EMIM-ES) and 1-ethyl-3-methyl imidazolium hexyl sulfate (EMIM-HS). However, other hygroscopic liquids (non-ionic liquids) could also be used for example isopropyl alcohol and neutral hygroscopic liquids such as triethylene glycol (TEG). Several hygroscopic ionic solutions such as potassium hydroxide (KOH), potassium acetate, potassium formate, sulfuric acid (H₂SO₄), lithium chloride (LiCl), sodium hydroxide (NaOH) and can be used in the process of the present invention as the hygroscopic liquid. In particular embodiments, the hygroscopic ionic liquid comprises aqueous sulfuric acid having a concentration of at least 30 wt %, preferably 50 wt %, and more preferably at least 60 wt %. High concentration sulfuric acid (at least 50 wt %) is preferred due to a higher water vapour chemical potential allowing it to capture moisture from the air. However, it should be appreciated that the concentration of aqueous sulfuric acid can be tailored to the anticipated water content (relative humidity) of the source of air.

The absorption step and the electrolysis step can occur in separate process units (two-unit process) or in the same process unit (single unit process) depending on how the water absorbed within the hygroscopic liquid undergoes electrolysis.

In some embodiments, the step of contacting the hygroscopic liquid with the source of air occurs in a separate process unit/apparatus to the electrolytically converting step (i.e. the two-unit process). In the two-unit process, an absorber unit can be used to perform the water absorption process, and a separate electrolyser can be used to perform the electrolysis step. Hygroscopic liquid is fed into the absorber unit, where it contacts air to absorb a water content therefrom. That water rich hygroscopic liquid then fed into one or more electrolysers, where the absorbed water is converted to hydrogen by electrolysis and can be collected. The now water lean hygroscopic liquid flows out from the electrolyser and can be optionally recycled back to the absorber unit. The electrolysers preferably follow the conventional design with liquid flowing through the electrolyser between a cathode and an anode.

In other embodiments, the step of contacting the hygroscopic liquid with the source of air occurs in the same process unit/apparatus to the electrolytically converting step (i.e. the single unit process). In this process, the absorption and electrolysis steps are combined in the same process unit, with that unit configured to hold the hygroscopic liquid in a configuration that allows the hygroscopic liquid to contact the source of air to absorb a water content of that air, and also undergo electrolysis therein. This will be explained in more detail below in relation to the second aspect of the invention (apparatus).

The hygroscopic liquid can be used in a variety of ways to absorb a water content from the source of air. In some embodiments, the hygroscopic liquid contacts air whilst being held in a container or other receptacle. However, in the single unit process, the hygroscopic liquid is preferably housed within a medium that allows the electrolyte to contact the source of air, whilst locating the electrolyte within an electrolyser or module for the electrolysis step. That medium preferably includes a network of connected flow paths, pores or similar spaces through which the electrolyte and its constituents can be located and flow, whilst also providing a contact area between the electrolyte and the source of air.

One suitable form of medium is a porous or fibrous substance or medium. In such embodiments, the hygroscopic liquid is contained in a porous and/or fibrous medium. A porous medium advantageously retains the hygroscopic liquid within the porous structure using capillary forces. This enables the hygroscopic liquid laden porous structure to be placed directly in air, with the air contacting the surface area of the porous medium to enable water to be absorbed into the hygroscopic liquid contained therein.

A variety of porous and/or fibrous medium could be used. The porous and/or fibrous medium is preferably selected to be compatible with the hygroscopic liquid, and therefore not be damaged by that liquid. Depending on the hygroscopic liquid, various polymer foams could be used such as polyurethane (PU) foam, polyvinyl alcohol (PVA) foam and melamine sponge (MS). However, for more acidic and/or alkaline hygroscopic liquids, the porous and/or fibrous medium may comprise a crystalline or glass-based foam. In embodiments, the porous and/or fibrous medium comprises at least one of a porous glass, or crystalline fiber medium. An example of a suitable porous glass, or crystalline fiber is a sintered glass foam or quartz wool. In some embodiments, the porous and/or fibrous medium comprises a combination of sintered glass foam and quartz wool which contain the hygroscopic liquid therein. Here both sintered glass foam and quartz wool are also used to contain the hygroscopic ionic solution in which hydrogen and oxygen are effectively isolated without mixing.

The dimensions and properties of the porous glass medium need to be suitable for free flow of the electrolyte through the medium, provide suitable conductivity through the medium and within the comprising electrolyser and also allow ion exchange and movement during electrolysis. For a porous material, fluid flow is connected to the pore size of that material. Accordingly, for a porous glass medium, for example a porous glass filter such as a porous glass foam, that medium preferable has a pore size of at least 10 μm, preferably at least 16 μm, and more preferably between 16 and 100 μm. For electrical conductivity, there is a trade-off between the water absorption area and conductivity effecting the dimensions of the porous glass medium that can be used in the hydrogen generation module. Resistance is proportional to the distance between the electrodes. Under specific current density, the gap between the cathode and anode electrodes should be as small as possible to maintain relatively high energy efficiency. Considering both factors, there needs to be sufficient mass transfer area for water absorption provided in the electrolyte while maintaining moderate energy efficiency. In embodiments, suitable electrical conductivity and water absorption can be provided when the porous and/or fibrous medium is at least 1 cm thick, and preferably at least 1.5 cm thick.

In some embodiments, the porous and/or fibrous medium comprises at least one sintered glass foam located between two separate layers of quartz wool. Here, the upper and lower surface of sintered glass foam is covered by quartz wool to ensure the connectivity within the electrolytic system, for example to electrodes therein. In such a stacked arrangement, a particular thickness can be formed using stacked layers of quartz wool and sintered glass foams. For example, for 1.5 cm total thickness, three filters and four layers of quartz wool can be used in a stacked arrangement, with each filter being sandwiched between a quartz wool layer.

In some embodiments, the porous and/or fibrous medium can be configured to increase the contact surface area between the hygroscopic liquid and the source of air. For example, in some embodiments, conduits, grooves, channels, cavities or other hollow features could be included in the porous and/or fibrous medium to enable air to flow through the porous and/or fibrous medium.

The electrolytically converting step preferably occurs in an electrolyser that includes the hygroscopic liquid. An electrolyser typically comprises a cathode electrode which is spaced apart from an anode electrode, having the electrolyte housed and electrically connected therebetween. The electrolytically converting step can therefore comprise:
applying an electrical current between spaced apart cathode and anode electrodes and through the hygroscopic liquid which is housed therebetween.

Electrolysis requires a suitable electrolyte to be present in the electrolyser between the cathode electrode and anode electrode. That electrolyte is preferably provided by the hygroscopic liquid. When functioning as an electrolyte, the hygroscopic liquid preferably comprises:
an electrolyte for electrolysis in the electrolytically converting step (for example an ionic liquid or a hygroscopic ionic solution is able to function as an electrolyte by the nature of its ionic components); or
a mixture of the hygroscopic liquid with an ionic solute to form the electrolyte for electrolysis in the electrolytically converting step.

Examples of suitable ionic solutes include Na₂SO₄, Li₂SO₄, Na₂CO₃, NaHCO₃, and K₂CO₃. However, it should be appreciated that other ionic solutes could also be used.

The electrical current for electrolysis can be provided by any suitable DC electricity source such as a battery, electrical generator (DC or rectified AC), or the like. For the present invention, it is preferred that the electrical current is provided by a renewable electricity source to enable the hydrogen generated to be green or renewable hydrogen. Thus, in exemplary embodiments the electrical current is provided by at least one solar cell/photovoltaic cell. The current/electricity source is preferably applied between each cathode and anode with a current density of at least 10 mA cm⁻², preferably at least 15.0 mA cm⁻². In embodiments, the current/electricity source applies a voltage between each cathode and anode of at least 2 V, preferably between 2 and 6 V.

It should be understood that water electrolysis (electrolysis of water) involves the splitting of the water molecule into hydrogen and oxygen through an electrochemical reaction driven by electrical or thermal energy. Water electrolysis generally requires two or more electrodes immersed in a suitable electrolyte that also contains a water content. While the electrodes have an electrical potential applied across the electrodes to induce a direct current (DC) which flows through the electrolyte. When the energy is high enough, the water disassociates into gaseous hydrogen and oxygen. This occurs as the water molecules are reduced by electrons at the cathode to form hydrogen gas (H₂) and hydroxide ions (OH⁻) following the reactions below:

Cathode: 4H⁺+4e→2H₂ (1)

Anode: 2H₂O→O₂+4H⁺+4e⁻ (2)

The negatively charged hydroxide ions then migrate towards the anode and are oxidised to form oxygen gas (O₂) and water, while releasing electrons to the current flow. The oxygen reduction reaction (ORR) occurs at the anode, and the hydrogen evolution reaction (HER) at the cathode enabling hydrogen to be collected at or proximate the cathode, and oxygen to be collected at or proximate the anode.

The HER reaction is thermodynamically arduous typically requiring a catalyst to help reduce the energy barrier and increase the reaction rate. The cathode therefore preferably includes a hydrogen evolution reaction catalyst. Advantageously, a platinum electrode provides an excellent catalyst for a hydrogen evolution reaction. Platinum (Pt) group metals are best suited for HER reactions to take place at a near-zero overpotentials in acidic medium. The cathode therefore preferably includes platinum, and more preferably comprises platinum.

As indicated above, hydrogen is produced at the cathode and oxygen at the anode following reactions 1 and 2. This allows hydrogen produced by electrolysis to be separated from the hygroscopic liquid proximate the cathode and oxygen produced by electrolysis to be separated from the hygroscopic liquid proximate the anode. The process of the present invention may therefore further comprise the step of collecting the produced hydrogen at or proximate the cathode electrode in a hydrogen product stream. Similarly, the process of the present invention may therefore further comprise the step of collecting the produced oxygen at or proximate the anode electrode in an oxygen product stream. Where a pure hydrogen product is required, that hydrogen product stream can undergo a scrubbing process to remove any moisture and/or oxygen in that stream. For example, the hydrogen product stream could be scrubbed by bubbling the hydrogen product stream through water.

The source of air can comprise any suitable gas source. However, it is envisioned that the process of the present invention is used in an external environment to harvest water and produce hydrogen. Therefore, the source of air preferably comprises atmospheric air. That air may have varying water content. In some embodiments, the source of air has a relative humidity a low as 4%. Here, the source of air may have a relative humidity of 4% or greater, for example between 4% and 100%. In some embodiments, the source of air has a relative humidity of between 10 and 100%, preferably between 10 and 80%, more preferably between 13 and 80%. In embodiments, the source of air has a relative humidity of between 20 and 80%. In some embodiments, the source of air has a relative humidity of less than 20%, preferably between 4% and 20%.

A second aspect of the present invention provides an apparatus for producing hydrogen from air comprising:
at least one absorber containing a hygroscopic liquid, the absorber being configured to contact the hygroscopic liquid with a source of air to absorb a water content from said source of air into the hygroscopic liquid; and
at least one electrolyser configured to electrolytically convert the water absorbed in the hygroscopic liquid into hydrogen and oxygen.

Like the first aspect, the apparatus of this second aspect is a direct air electrolysis (DAE) unit which captures water from air using a hygroscopic liquid which can then be converted to hydrogen by electrolysis between the cathode and the anode of an electrolyser. The DAE is preferably designed and operated to consistently produce pure hydrogen under a wide range of relative humidity (for example from 4% to 100%, and in some embodiments between 20% to 80%, in other embodiments with a relative humidity or less than 20%) while maintaining stable performance over an extended period of time.

As with the first aspect, the hygroscopic liquid preferably comprises an ionic liquid or a hygroscopic ionic solution. Examples of ionic liquids include imidazolium based ionic liquids such as 1-ethyl-3-methyl imidazolium ethyl sulfate (EMIM-ES) and 1-ethyl-3-methyl imidazolium hexyl sulfate (EMIM-HS). In embodiments, the hygroscopic liquid is selected from at least one of potassium hydroxide (KOH), potassium acetate, potassium formate, sulfuric acid (H₂SO₄), lithium chloride (LiCl), sodium hydroxide (NaOH), isopropyl alcohol or triethylene glycol (TEG). In some embodiments, the hygroscopic ionic liquid comprises aqueous sulfuric acid having a concentration of at least 30 wt %, preferably at least 50 wt %, and more preferably at least 60 wt %. High concentration sulfuric acid (at least 50 wt %) is preferred due to a higher water vapour chemical potential allowing it to capture moisture from the air.

Each electrolyser requires a suitable electrolyte to be present between a cathode electrode and an anode electrode of that cell. That electrolyte is preferably provided by the hygroscopic liquid. When functioning as an electrolyte, the hygroscopic liquid comprises:
an electrolyte for electrolysis in the at least one electrolyser (for example an ionic liquid or a hygroscopic ionic solution is able to function as an electrolyte by the nature of its ionic components); or
a mixture of the hygroscopic liquid (for example TEG) with an ionic solute to form the electrolyte for electrolysis in the at least one electrolyser.

Again, examples of suitable ionic solutes include Na₂SO₄, Li₂SO₄, Na₂CO₃, NaHCO₃, and K₂CO₃. However, it should be appreciated that other ionic solutes could also be used.

The hygroscopic liquid is typically housed or otherwise contained in the absorber within a medium, preferably a porous and/or fibrous medium. In embodiments, porous and/or fibrous medium comprises at least one of a porous glass, or crystalline fiber medium. As noted for the first aspect, the porous and/or fibrous medium is preferably selected to be compatible with the hygroscopic liquid, and therefore not be damaged by that liquid. Depending on the hygroscopic liquid, various polymer foams could be used such as polyurethane (PU) foam, polyvinyl alcohol (PVA) foam and melamine sponge (MS). However, for more acidic and/or alkaline hygroscopic liquids, the porous and/or fibrous medium may comprise a crystalline or glass-based foam. In some embodiments, the porous and/or fibrous medium comprises at least one of a sintered glass foam or quartz wool, preferably a combination of sintered glass foam or quartz wool which contain the hygroscopic liquid therein. In such embodiments, the porous and/or fibrous medium preferably comprises at least one sintered glass foam located between two separate layers of quartz wool. The upper and lower surface of sintered glass foam is preferably covered by quartz wool to ensure the connectivity of the porous and/or fibrous medium with the electrodes in the stack. As noted previously, both sintered glass foam and quartz wool are also used to contain the hygroscopic ionic solution in which hydrogen and oxygen are effectively isolated without mixing.

As previously discussed, the properties of the porous and/or fibrous medium can affect the function of the hydrogen generation apparatus. In embodiments, the porous glass medium comprises a porous glass filter having a pore size of at least 10 μm, preferably at least 16 μm, more preferably between 16 and 100 μm. In embodiments, the porous and/or fibrous medium is at least 1 cm thick, preferably at least 1.5 cm thick.

Again, in some embodiments, the porous and/or fibrous medium can be configured to increase the contact surface area between the hygroscopic liquid and the source of air. For example, in some embodiments, conduits, grooves, channels, cavities or other hollow features could be included in the porous and/or fibrous medium to enable air to flow through the porous and/or fibrous medium.

Similar to the first aspect, the absorber and the electrolyser of this second aspect of the present invention can comprise separate process units (two-unit process) or be incorporated into the same process unit (single unit process).

In the two-unit process configuration, the at least one absorber and the at least one electrolyser comprise separate process units/equipment. In this configuration, an absorber unit can be used to perform the water absorption process, and a separate electrolyser can be used to perform the water electrolysis to produce hydrogen and oxygen. Hygroscopic liquid is fed into one or more absorber unit, where it contacts air to absorb a water content therefrom. That water rich hygroscopic liquid then fed into one or more electrolysers, where the absorbed water is converted to hydrogen by electrolysis and can be collected. The now water lean hygroscopic liquid flows out from the electrolyser and can be optionally recycled back to the absorber unit.

The absorber can comprise a suitable gas-liquid contacting process unit, for example a packed bed absorber, spray absorber, bubble mixer or the like. As noted for the first aspect, the electrolysers preferably follow the conventional design with liquid flowing through the electrolyser between a cathode and an anode.

In the single unit process configuration, the at least one absorber and the at least one electrolyser are included in the same process unit. In this configuration, the absorber and electrolyser are combined in the same process unit, with that unit configured to hold the hygroscopic liquid in a configuration that allows the hygroscopic liquid to contact the source of air to absorb a water content of that air, and also undergo electrolysis therein. Typically, this involves holding the hygroscopic liquid in a container or medium between an anode and a cathode of an electrolyser. It should be noted that this type of absorption electrolyser design is different to standard electrolyser designs as it does not include any liquid flow between the cathode and anode. In this case, water does not flow into the electrolyser, but rather the electrolyte is used to absorb the water, and this is electrolysed insitu with no liquid water flow into or out from the electrolyser. In embodiments, the apparatus can therefore further comprise a combined absorber and electrolyser that comprises a cathode; an anode, and the hygroscopic liquid situated between the cathode and anode which is in contact with or otherwise can be contacted with the source of air.

An electrical source can be used to provide the required bias for water electrolysis. In some embodiments, the apparatus further comprises an electrical source having a positive terminal and a negative terminal; wherein the cathode is electrically connected to the negative terminal of the electrical source, and the cathode is electrically connected to the negative terminal of the electrical source, the electrical source is configured to supply an electrical current between the cathode electrode and anode electrode to electrolytically split water absorbed in the hygroscopic liquid into hydrogen and oxygen.

In embodiments, the electrical source comprises a renewable electricity source, preferably at least one solar cell/photovoltaic cell. The use of a renewable electricity source such as a solar to power the water splitting reactions alleviates the need for an external source of thermal energy, water purification or gas separation and offers a sustainable pathway to produce high purity H₂.

The cathode and anode can have any suitable configuration to distribute current from the electrical source to the hygroscopic liquid. In some embodiments, the cathode comprises a cathode current collector/distributor and electrically connected cathode electrode, the cathode current collector/distributor being connected to the negative terminal of the electrical source, and the anode comprising an anode electrode electrically connected to an anode current collector/distributor which is connected to the negative terminal of the electrical source. It should be appreciated that the cathode current collector/distributor and the cathode electrode can be separate components or integral components in embodiments. Similarly, it should be appreciated that the anode current collector/distributor and the anode electrode can be separate components or integral components in embodiments.

The cathode preferably includes a hydrogen evolution reaction catalyst, for example platinum. Thus, in some embodiments, the cathode, and preferably the cathode electrode of the electrolyser includes platinum. In some embodiments, the cathode electrode comprises a platinum electrode. As noted previously, a platinum electrode advantageously provides an excellent catalyst for a hydrogen evolution reaction.

The anode and cathode, and the comprising anode electrode and cathode electrodes can have any suitable configuration. In some embodiments, the anode electrodes and the cathode electrodes comprise a metallic mesh, preferably platinum mesh electrodes. Similarly, the anode and cathode current collectors/distributors can have any suitable configuration. In embodiments, the anode and cathode current collectors/distributors comprise an insulator plate including a conductive wire, preferably a Teflon plate with Pt wireline embedded therein.

The electrical source generates an electrical current provides the required bias between the electrodes to achieve efficient water splitting reactions, with the oxygen reduction reaction (ORR) at the anode, and the hydrogen evolution reaction (HER) at the cathode. The cathode includes a HER catalyst as this reaction is thermodynamically arduous typically requiring a catalyst to help reduce the energy barrier and increase the reaction rate.

The electrical source can comprise any direct current electrical source capable of providing sufficient voltage and current to achieve the water splitting reaction in each hydrogen generation module. In embodiments, the at least one electrolyser is powered by an electrical source comprising a renewable electricity source, preferably at least one solar cell.

In order to achieve water splitting, the electrical source preferably produces a current density of at least 10 mA cm⁻², preferably at least 15.0 mA cm⁻². The electrical source also preferably applies a voltage between each cathode and anode of at least 2 V, more preferably between 2 and 6 V.

Again, the hydrogen produced by electrolysis is separated from the hygroscopic liquid proximate the cathode and the oxygen produced by electrolysis is separated from the hygroscopic liquid proximate the anode. The apparatus can therefore further comprise hydrogen product stream fluidly connected at or proximate the cathode through which the produced hydrogen flows out from the at least one hydrogen generation module. Similarly, the apparatus can further comprise an oxygen product stream fluidly connected at or proximate the anode configured through which the produced oxygen flows out from the at least one hydrogen generation module. The hydrogen product stream may be further processed, for example scrubbed of oxygen and/or water to produce an acceptable product.

The source of air can comprise any suitable gas source. However, it is envisioned that the process of the present invention is used in an external environment to harvest water and produce hydrogen. Therefore, the source of air preferably comprises atmospheric air. That air may have varying water content. In some embodiments, the source of air has a relative humidity a low as 4%. Here, the source of air may have a relative humidity of 4% or greater, for example between 4% and 100%. In some embodiments, the source of air has a relative humidity of between 10 and 100%, preferably between 10 and 80%, more preferably between 13 and 80%. In embodiments, the source of air has a relative humidity of between 20 and 80%. In some embodiments, the source of air has a relative humidity of less than 20%, preferably between 4% and 20%.

The apparatus may comprise at least one hydrogen generation module, wherein each hydrogen generation module comprises said at least one absorber and said at least one electrolyser. The apparatus of the present invention can include one, two or any number of hydrogen generation modules comprising at least to scale up hydrogen production to a desired production rate. In such embodiments, the apparatus further comprises at least two hydrogen generation modules connected in parallel. Multiple hydrogen generation modules can be connected in parallel, or if desired in series.

The hydrogen production rate is dependent on many factors, including nature of the electrical supply, atmospheric moisture content, hygroscopic liquid properties and the like. However, in embodiments the apparatus has a hydrogen production rate of at least 0.10 ml cm⁻²_{electrode} min⁻¹.

A third aspect of the present invention provides a process according to the first aspect of the present invention that is performed using the apparatus of the second aspect of the present invention.

The DAE process and apparatus of the present invention creates a new market for green hydrogen generation. Hydrogen produced using renewable energy sources is often referred to as “green” or “renewable” hydrogen. When a life-cycle analysis is completed to compare processes of hydrogen production, renewable hydrogen production presents minimal environmental impacts compared to hydrogen produced with fossil fuels. The process and apparatus of the present invention can overcome the water shortage issue and produce green hydrogen sustainably without geographic limitations.

### BRIEF DESCRIPTION OF THE DRAWINGS

The present invention will now be described with reference to the figures of the accompanying drawings, which illustrate particular preferred embodiments of the present invention, wherein:

FIG. 1A provides a process diagram of a process according to one embodiment of the present invention.

FIG. 1B provides a schematic representation of one direct air electrolysis (DAE) module according to one embodiment of the present invention in which a solar panel provides the electrolysis bias and a hygroscopic liquid harvests water from humid air.

FIG. 1C provides a schematic diagram of the cross-section of the DAE module, showing the electrodes are isolated from the air feed, and the absorbed water are transported to the electrode by capillaries of the sponge.

FIG. 1D provides a schematic representation of an apparatus that includes five parallel connected DAE modules for direct hydrogen generation from air according to one embodiment of the present invention.

FIG. 1E provides an exploded perspective view of the stacked layers of one DAE module of the apparatus shown in FIG. 1D with no anode gas collection.

FIG. 1F provides an exploded perspective view of the stacked layers of one DAE module of the apparatus shown in FIG. 1D with anode gas collection.

FIG. 1G provides a plot of the equilibrium water uptakes of different hygroscopic solutions at different relative humidity's.

FIG. 1H provides J-V curves for direct air electrolysis (DAE) modules using Pt or Ni electrodes sandwiched with KOH electrolyte (in equilibrium with 15% and 60% R.H. at 20° C.) soaked in a melamine sponge.

FIG. 1I provides (a) a JV curve showing the effect of sponge materials on J-V performance of DAE modules using H₂SO₄ electrolyte in equilibrium with 30% R.H. at 25° C.; and (b) the inset which shows the optical micro image for the glass foam.

FIG. 1J provides a gas chromatography composition ploy of the gas production at the anode by electrolysing 50 wt % CH₃COOK showing substantial carbon dioxide (1.515 min), ethane (1.756 min), hydrogen (3.589 min) and methane (4.584 min) observed with oxygen (3.780 min).

FIG. 2A provides (a) a photograph of a sinter glass foam used in the DAE modules shown in FIGS. 1B, 1D and 1E; and (b) the stacking arrangement of the porous and fibrous medium used to contain the hygroscopic liquid.

FIG. 2B provides a photograph of a platinum mesh electrode that can be used in the DAE modules shown in FIGS. 1B, 1D and 1E.

FIG. 2C provides a SEM images of glass foam used in experiments, showing a) G1 glass foam; b) G2 glass foam; and c) G3 glass foam.

FIGS. 3a to 3f provide experimental results of the performance of a DAE module according to the present invention, showing:

FIG. 3a provides J-V curves from modules while using various filters with different pore sizes (G1-G3 denotes the pore size, experiment conditions: 62.0 wt % H₂SO₄, 25° C., 1.5 cm represents the total thickness combining sintered glass foams and quartz wool).

FIG. 3b shows J-V curves from modules while using various filters with different thickness (1.5-2.5 cm represents the thickness of combining G1 sintered glass foams and quartz wool, experiment conditions: 62.0 wt % H₂SO₄, 25° C.).

FIG. 3c provides a plot of the dynamic equilibrium concentration at J=15.0 mA cm⁻² (circles) VS equilibrium concentration (squares) under different R.H., The inset shows the effect of current density on dynamic concentration while operating under 80% R.H. (experiment conditions: 1.5 cm total thickness combining G1 sintered glass foams and quartz wool, 25° C.).

FIG. 3d shows J-V curves from modules under dynamic equilibrium concentration with the current density equals to 30 while operating under different R.H. (experiment conditions: 1.5 cm total thickness combining G1 sintered glass foams and quartz wool, 25° C.).

FIG. 3e provides a plot of a recording of voltage (squares) and H₂SO₄ concentration (circles) from DAE modules while using a D.C. power supply at constant current density 15.0 mA cm⁻² for 288 hours (experiment conditions: 40% R.H. and 25° C.).

FIG. 3f provides a plot of a recording of current density collected from the J-V behaviour under specific voltage for 288 hours (experiment conditions: 40% R.H. and 25° C.).

FIG. 3g provides a) J-V curves with 62.5 wt % H₂SO₄ (in equilibrium with 13% R.H. at 25° C.) for modules under liquid electrolyte, DAE module and iR-corrected J-V curves for DAE module; b) iR-corrected J-V curves for DAE module under different H₂SO₄ concentration.

FIG. 3h provides a plot of Kinematic viscosity (Cp.) vs concentration (wt %) of sulfuric acid at 25° C.

FIG. 3i provides a plot of J-V curves and series resistances with KOH electrolyte (in equilibrium with 15% at 20° C.) for DAE module using melamine sponge and foam-free electrolyser.

FIG. 4A provides a plot of conductivity (mhos) vs concentration (wt %) of sulfuric acid at 25° C.

FIG. 4B provides plots showing the J-V behaviour for operating over 48 h at (a) R.H.=20%; (b) R.H.=40%; (c) R.H.=60%; and (d) R.H.=80%

FIG. 4C provides a plot illustrating the open environment measurements with DAE tower, showing: (a) A recording of current (mA) for DAE tower each hour; and (b) A recording of voltage (V) for DAE tower.

FIG. 4D provides a plot showing the H₂ Faradaic efficiency for prototype powered with the power supply at a constant overall current 400.0 mA (Similar as the solar panel). The H₂ Faradaic efficiency is around 95.8%, and the ideal H₂ volumes were calculated by assuming 100% faradaic efficiency for these products.

FIG. 4E provides a gas chromatograph (GC) results for (a) cathode gas production; and (b) pure H₂.

FIG. 4F provides a plot of the O₂ faradaic efficiency measured during this 15-minute trial was 91.0% under J=50 mA cm⁻². The ideal O₂ volumes were calculated by assuming 100% faradaic efficiency.

FIG. 4G provides a gas chromatograph (GC) results for (a) anode gas production; (b) pure O₂.

FIG. 5 provides the experimental results of open atmospheric environment measurements with DAE tower configured according to an embodiment of the present invention, showing: a) a photograph of the experimental tower featuring five parallel connected DAE modules. b) Plot showing the hydrogen generation rate each hour, the ambient relative humidity and temperature. The line with circles indicates hydrogen generation, the line with squares indicates the faradaic efficiency, and the top broken line indicates the faradaic efficiency when it equals 100%.

FIG. 6 provides a J-V plot of a triple junction solar cell and DAE module performance under different H₂SO₄ concentration.

FIG. 7 provides a photo of a DAE module according to an embodiment of the present invention coupled with a wind turbine as a power generation source for water electrolysis.

### DETAILED DESCRIPTION

The present invention provides a direct air electrolysis (DAE) process and apparatus for producing and collecting high purity hydrogen and oxygen by water electrolysis. Water is harvested from surrounding air, being absorbed into a hygroscopic liquid. That absorbed water then undergoes electrolytic water splitting to produce hydrogen. This process enables the production of hydrogen without consuming freshwater. The only energy input into the system is electrical energy, preferably provided by renewable energy (for example by solar power such as photovoltaic/solar cells as demonstrated in the examples in this specification).

### Two-Unit Process

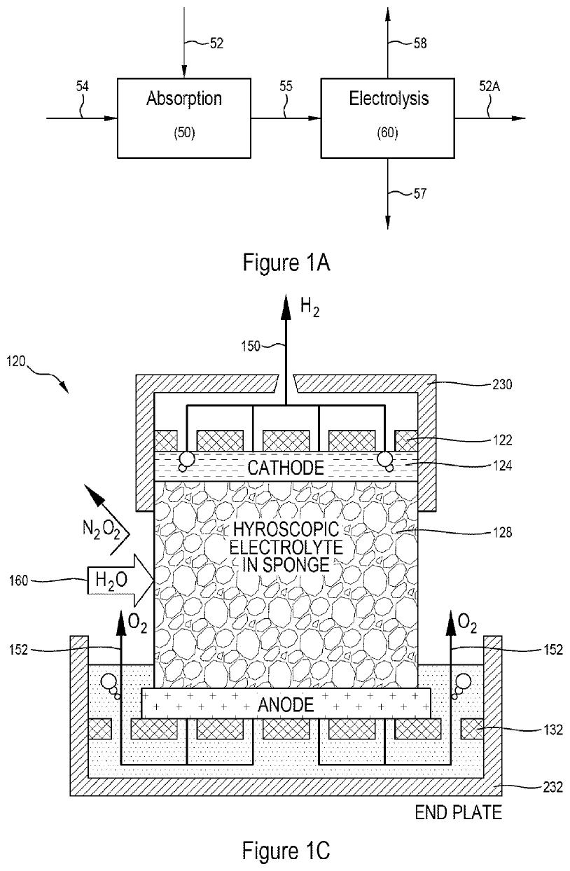

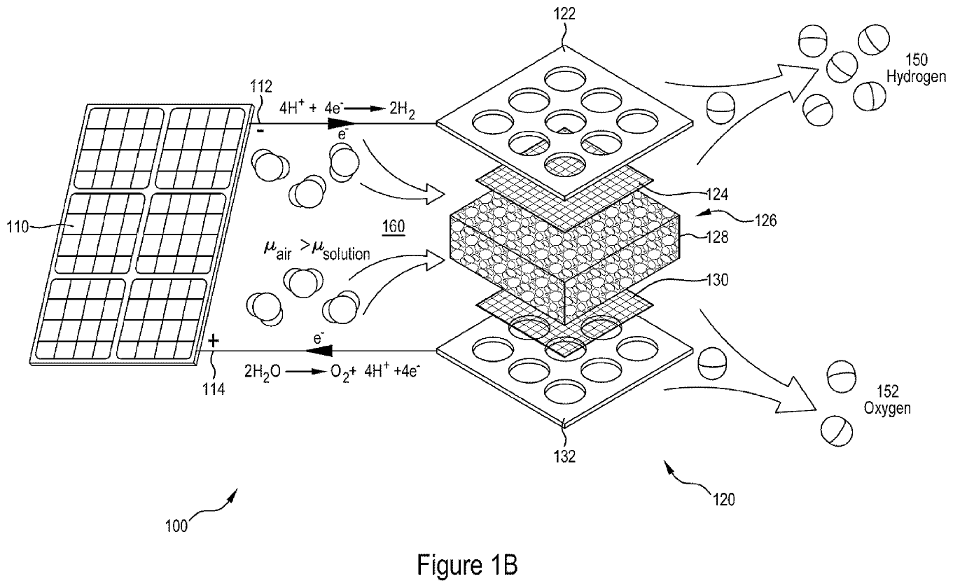

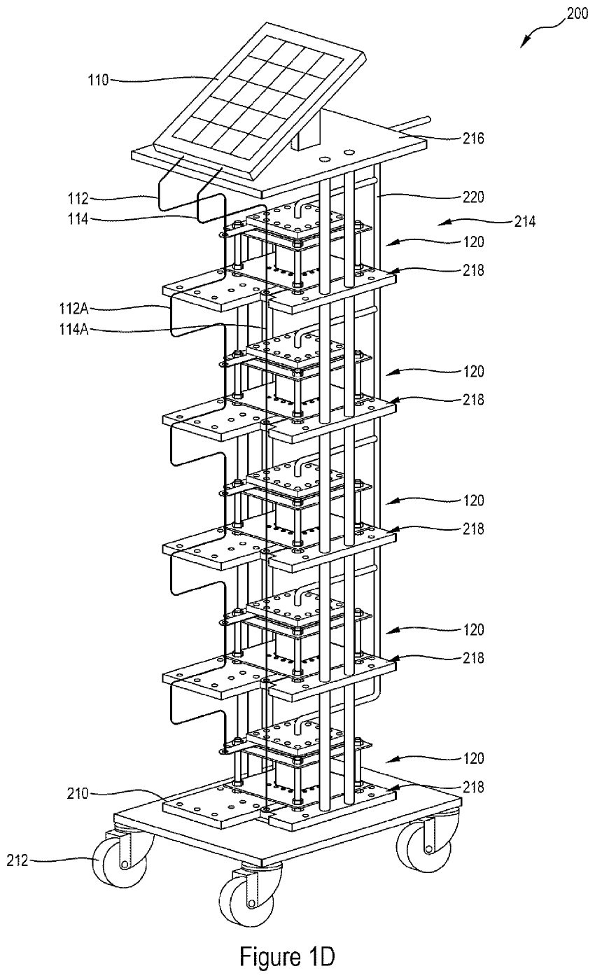

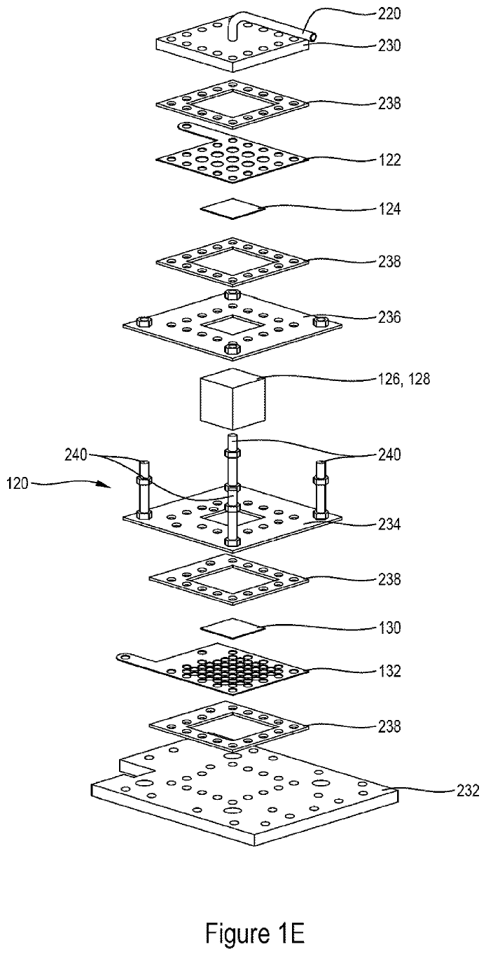

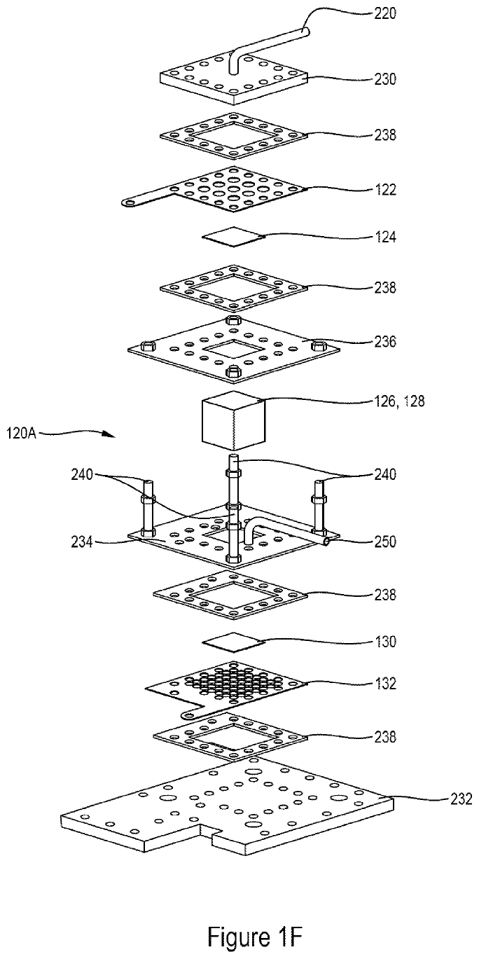

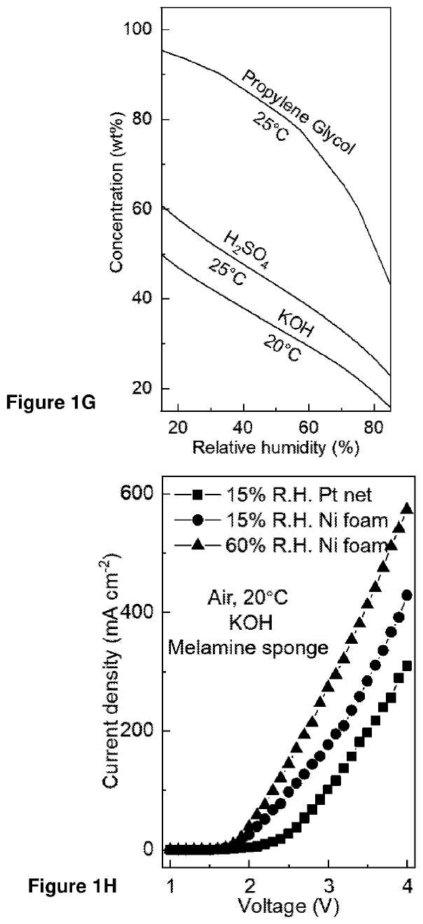

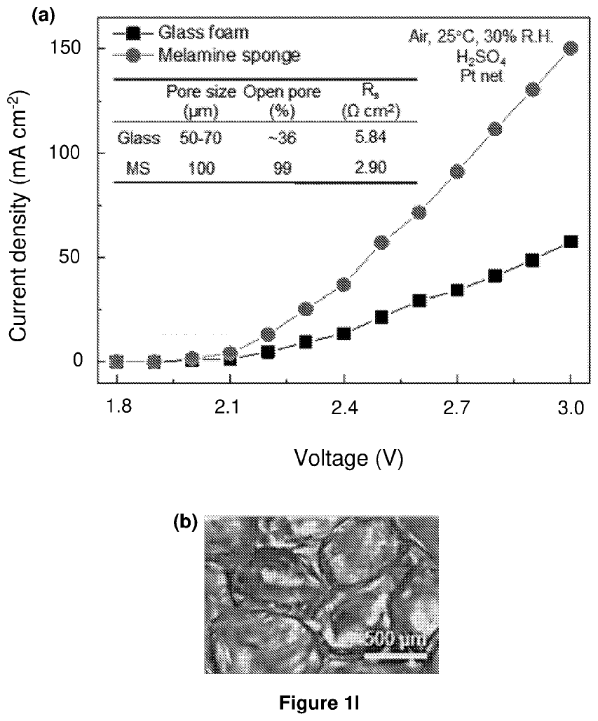

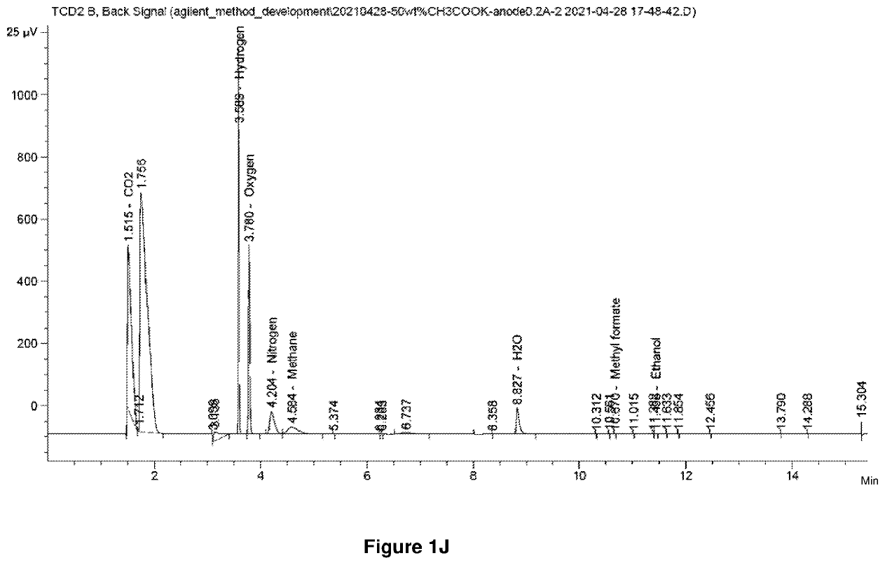

As illustrated in the process diagram of FIG. 1A, the process of the present invention involves two steps:
STEP ONE—Absorption 50: contacting a hygroscopic liquid 52 with a source of air 54 to absorb a water content from said source of air into the hygroscopic liquid, to produce a water rich hygroscopic liquid 56; and
STEP TWO—Electrolysis 60: electrolytically converting the water absorbed in the water rich hygroscopic liquid 55 into hydrogen 58 and oxygen 57.

These two steps can be undertaken in the same process equipment or separate process equipment.

When step one and step two are undertaken in separate process equipment, water lean hygroscopic liquid 52 fed into the absorption process equipment 50 and is first contacted with water laden air 52 (for example air with a relative humidity between 4% and 100%, such as between 20% and 80%; or with a relative humidity of less than 20%). This contact can be via the air contacting a surface of the hygroscopic liquid 52, a packed bed absorber, spray absorber, bubble mixer, or other gas-liquid absorber configuration to absorb a water content therein from the air source 54 to produce a water rich hygroscopic liquid 55. That water rich hygroscopic liquid 55 is then fed into one or more electrolysers 60, where the absorbed water is converted to hydrogen by electrolysis between a cathode and an anode in the electrolysers 60. The hydrogen 58 and oxygen 57 are separated from the hygroscopic liquid 52 at or proximate the respective cathode and anode, and the now water lean hygroscopic liquid 52A flows out from the electrolyser. That hygroscopic liquid 52A can be optionally recycled back to the absorption process equipment 50.

The water rich hygroscopic liquid 55 can act as the electrolyte within the electrolyser 60 or if necessary, can be mixed or otherwise doped with an ionic solute to provide the requisite ionic properties for electrolysis. These options are discussed later in this specification.

In this two-unit process, the electrolysers 60 follow a standard design with liquid flowing through the electrolyser 60 between spaced apart cathodes and anodes thereof (not illustrated). Any suitable conventional electrolyser design could be used to achieve water splitting of the absorbed water in the water rich hygroscopic liquid 55.

### Single Unit Process

When the absorption and the electrolysis steps are undertaken in the same process equipment, the apparatus is configured to hold the hygroscopic liquid 52 within the electrolyser 60 in a configuration that also allows the hygroscopic liquid 52 to contact the source of air 54 to absorb a water content of that air. Typically, this involves holding the hygroscopic liquid in a container or medium between an anode and a cathode of each electrolyser 60. As previously noted, this type of combined absorber and electrolyser design is different to standard electrolyser designs as it does not have any liquid flow between the cathode and the anode. In this case, water for water electrolysis does not flow into the electrolyser 60, but rather the electrolyte or a component within the electrolyte is used to absorb water from a contacting or surrounding source of air, and that absorbed water content is electrolysed insitu, with no liquid water flowing into, through or out from the electrolyser 60.

One embodiment of a single step DAE apparatus 100 of the present invention is shown in FIGS. 1B to 1F. The DAE apparatus 100 illustrated in FIG. 1B includes a solar panel 110 for electricity generation and an electrolysis module 120 which also includes a water harvesting unit 128 therein. Whilst the power supply is illustrated as a solar panel in FIG. 1B, it should be appreciated that this power supply could comprise any power generator, preferably a renewable power generator for example, a solar panel or other solar power generating device, a wind turbine or any other renewable generators. The electrolysis module 120 includes a hygroscopic electrolyte which is used to absorb moisture from the surrounding air. Electrolysis is then powered by solar-generated electricity to split the absorbed water to obtain pure H₂.

As shown in FIGS. 1B, 1D, 1E and 1F the DAE 100, 200 includes at least one (in the case of FIGS. 1D and 1E, five) electrolysis modules 120. As best illustrated in FIGS. 1B, 1E and 1F (from the top to bottom) each electrolysis module 120 comprises a water harvesting unit 126 in the middle and electrodes 124, 130. This arrangement forms a tightly stacked layer structure having a cathode current collector 122, cathode electrode 124, a water harvesting unit 126 comprising a fibrous and porous medium 126 containing the hygroscopic electrolyte, an anode electrode 130 and an anode current collector 132. The layers of each electrolysis module 120 are configured to be electrically connected with each adjoining layer.

### Water Harvesting Unit

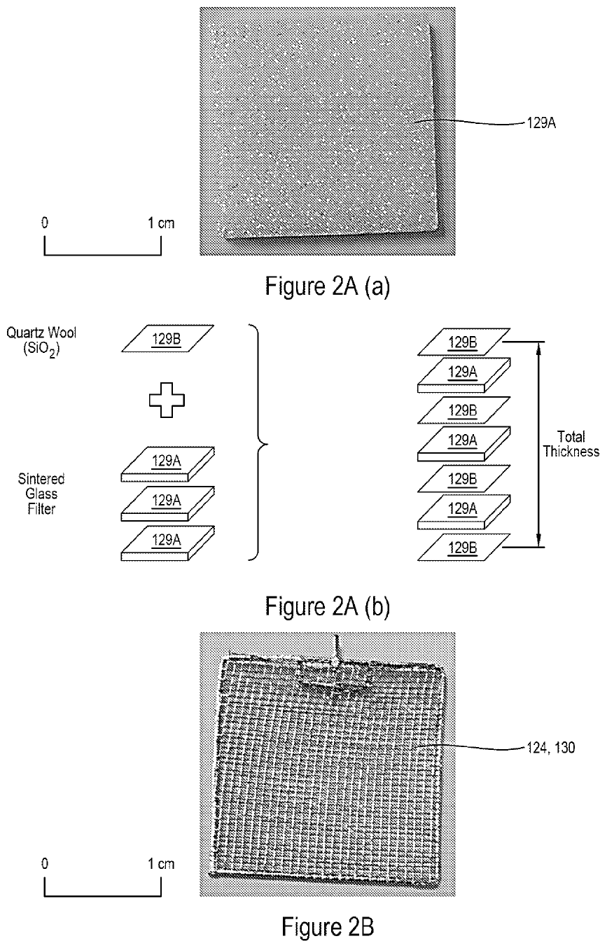

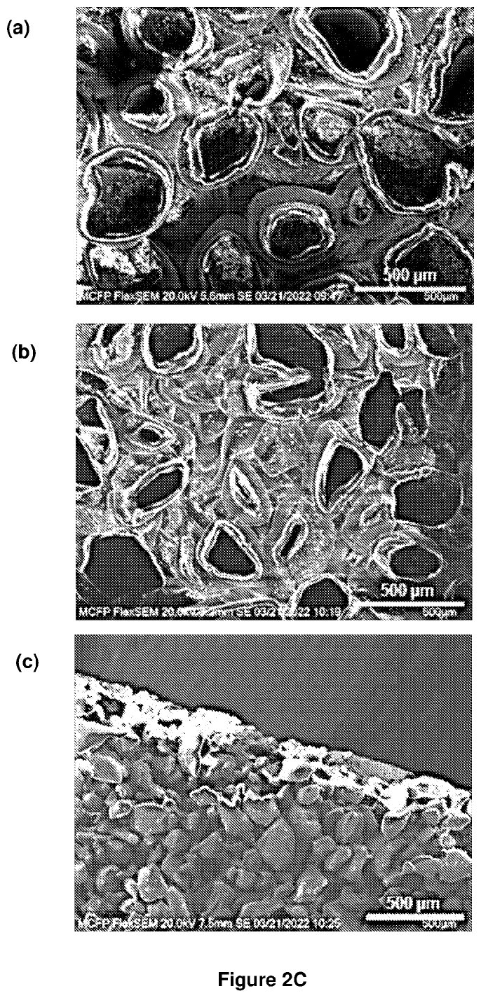

The water harvesting unit 126 includes the hygroscopic liquid used to absorb a water content 160 from the surrounding air as well functioning as the electrolyte for electrolysis. That hygroscopic liquid may be contained or fed in liquid form within the water harvesting unit 126 without a housing medium. Alternatively, the hygroscopic liquid may be contained within a holding/distribution medium, for example a porous and/or fibrous medium 128 (as illustrated in FIG. 1B to 1F and FIG. 2A) such as a melamine sponge, or sintered glass foam (see below). A porous medium 128 advantageously retains/captures the hygroscopic liquid within the porous structure using capillary forces. This enables the hygroscopic liquid laden porous structure to be placed directly in air, with the air contacting the surface area of the porous medium 128 to enable water to be absorbed into the hygroscopic liquid contained therein. The porous medium 128 also ensure the free movement of the electrolyte in the capillary of the foam. The foam filled with ionic solutions forms a physical barrier that effectively isolates hydrogen, oxygen, and air from any mixing.

In the illustrated embodiment that porous and/or fibrous medium 128 comprises a layer structure of sintered glass foams 129A and quartz wool 129B. As shown in FIG. 2A, the porous and/or fibrous medium 128 is preferably structured with each sintered glass foam 129A located between two separate layers of quartz wool 129A. This results in the upper and lower surface of each sintered glass foam 129A is covered by quartz wool 129B to ensure the connectivity of the porous and/or fibrous medium 128 with the electrodes 124, 130 in the stacked layers of each electrolysis module 120. In such a stacked arrangement, a particular thickness can be formed using stacked layers of quartz wool 129B and sintered glass foams 129A. As shown in FIG. 2A, for 1.5 cm total thickness, three filters 129A and four layers of quartz wool 129B can be used in a stacked arrangement, with each filter 129A being sandwiched between a quartz wool layer 129B. The sintered glass foams 129A can have a variety of properties. In some embodiments, each sintered glass foams 129A has a pore size of at least 10 μm, preferably between 16 and 100 μm. Both the sintered glass foam 129A and quartz wool 129B contain the hygroscopic ionic solution in which hydrogen and oxygen are effectively isolated without mixing.

### Hygroscopic Liquid

The water harvesting unit 126 includes a hygroscopic liquid that harvests water 160 from humid air. Hygroscopic substances characterized with a strong affinity with water tend to extract moisture from the atmosphere at exposure, absorbing sufficient water to form an aqueous solution which is hygroscopic in nature. Examples of suitable hygroscopic liquids include ionic liquids, hygroscopic ionic solutions, or non-ionic and/or a neutral hygroscopic liquid such as isopropyl alcohol or triethylene glycol which is doped with an ionic solute. For hygroscopic liquids, when the chemical potential (u) of water in the atmosphere is higher than the chemical potential of water in the hygroscopic liquid (μₐᵢᵣ>μₛₒₗᵤₜᵢₒₙ), the solution can absorb water vapour in the air until the vapour-liquid equilibrium is reached at μₐᵢᵣ=μₛₒₗᵤₜᵢₒₙ, making the concentration of the solution C equal to the equilibrium one C* (see for example FIG. 1G). The absorptive flux depends linearly on the difference between the concentration of water at the gas-liquid interface and the equilibrium value of the concentration of water in the liquid when there is no net absorption.

An ionic liquid is a salt in the liquid state. In some contexts, the term has been restricted to salts whose melting point is below some arbitrary temperature, such as 100° C. (212° F.). While ordinary liquids such as water and gasoline are predominantly made of electrically neutral molecules, ionic liquids are largely made of ions. These substances are variously called liquid electrolytes, ionic melts, ionic fluids, fused salts, liquid salts, or ionic glasses. Examples include imidazolium based ionic liquids such as 1-ethyl-3-methyl imidazolium ethyl sulfate (EMIM-ES) and 1-ethyl-3-methyl imidazolium hexyl sulfate (EMIM-HS), which have been shown to be extremely hygroscopic, in “Experimental measurement of the hygroscopic grade on eight imidazolium based ionic liquids”, Fluid Phase Equilibria, Volume 278, Issues 1-2, 15 Apr. 2009, Pages 36-40, the contents of which should be understood to be incorporated into this specification by this reference.

A non-ionic and/or neutral hygroscopic liquid which is doped with an ionic solute can also be used as the electrolyte. The ionic solute doping allows the liquid to act as an electrolyte, whilst the neutral hygroscopic liquid-such as triethylene glycol-provides the hygroscopic properties. Examples of suitable ionic solutes include Na₂SO₄, Li₂SO₄, Na₂CO₃, NaHCO₃, and K₂CO₃. However, it should be appreciated that other ionic solutes could also be used.

In many cases, the hygroscopic liquid will comprise an ionic solute. A limited number of hygroscopic ionic solutions can be used to absorb water vapour under low relative humidity (less than 20%), including KOH, NaOH, LiCl, NaOH, CH₃COOK, KCOO and H₂SO₄. Although KOH has the advantages of high conductivity and low capital cost, it presented with challenges. It can react with the atmosphere's carbon dioxide, producing K₂CO₃, even KHCO₃, which cannot absorb water vapour for R.H.<20%. For LiCl, a high concentration LiCl solution will cause a side reaction at the anode, generating Cl₂. However, among the investigated electrolytes, H₂SO₄ can absorb water vapour from a low R.H. environment with high conductivity. Hence, of these options, H₂SO₄ features a promising electrolyte for the DAE framework.

For the present invention, high concentration sulfuric acid is preferred as the hygroscopic liquid. In most cases, aqueous sulfuric acid having a concentration of at least 30 wt %. Sulfuric acid is a highly hygroscopic substance, increasing its volume by absorbing water from a high relative-humidity environment. When water vapour is absorbed, the volume of the sulfuric acid solution increases and consequently dilutes the acid concentration. It should be appreciated that the hygroscopic properties of sulfuric acid have been studied in the past, for example in Kiradjiev et al. A Simple Model for the Hygroscopy of Sulfuric Acid. Ind. Eng. Chem. Res. 2020, 59, 4802-4808, the contents of which should be understood to be incorporated into this specification by this reference.

The required concentration is dependent on the water content (relative humidity) of the air that is contacting the hygroscopic liquid (FIG. 1G). However, in many cases high concentration sulfuric acid (at least 50 wt %) is preferred due to a higher water vapour chemical potential allowing it to capture moisture more effectively from the air. Thus, in many situation, aqueous sulfuric acid having a concentration of at least 50 wt %, preferably at least 60 wt % may be required. Advantageously, high concentration sulfuric acid can operate in a wide range of relative humidity as shown in FIG. 1G.

The hygroscopic liquid is also used as the electrolyte in the electrolyser 120, 120A either using its inherent ionic properties—for example an ionic liquid or a hygroscopic ionic solution is able to function as an electrolyte by the nature of its ionic components); or as a mixture of the hygroscopic liquid (for example TEG) with an ionic solute to form the electrolyte for electrolysis in the electrolytically converting step.

### Current Collectors and Platinum Electrodes

The illustrated anode electrode 130 and cathode electrode 124 comprise platinum mesh electrodes (best shown in FIG. 2B). Pt mesh was selected as the best choice for electrodes 124, 130 due to the use of high concentration H₂SO₄ (at least 50 wt %) as the hygroscopic liquid/electrolyte. Platinum electrodes also advantageously provide an excellent hydrogen evolution reaction catalyst. Platinum wires was also used to construct current feed lines in the electrolyser 120, 120A.

The anode current collector/distributor 132 and cathode current collector/distributor 122 can have any suitable configuration. In the illustrated embodiments, the anode and cathode current collectors/distributors 122, 132 comprise a Teflon plate with Pt wireline embedded therein.

### Electrolyser

The solar panel 110 generates an electrical current provides the required bias between the electrodes of each electrolyser 120, 120A to achieve efficient water splitting reactions, with the oxygen reduction reaction (ORR) at the anode electrode 130, and the hydrogen evolution reaction (HER) at the cathode electrode 124. This generates hydrogen at the cathode electrode 124, which can be collected, and oxygen at the anode electrode 130, which can also be collected.

### Solar Panel

As shown in FIGS. 1B and 1D, the solar panel 110 comprises a plurality of solar cells of the solar panel provides an electrical current with the negative terminal 112 connected to the cathode current collector 122 and the positive terminal 114 connected to the anode current collector 132 to enable a current to pass through the hygroscopic electrolyte held therebetween.

The illustrated solar panel 110 comprises a consumed silica solar panel having a plurality of solar cells, providing a current density of at least 10 mA cm⁻², preferably at least 15.0 mA cm⁻², and a voltage between each cathode electrode 124 and anode electrode 130 of at least 2 V, more preferably between 2 and 6 V.

In operation, the porous and/or fibrous medium 128 is soaked with the hygroscopic liquid and water 160 from the surrounding air is absorbed into that hygroscopic liquid within the water harvesting unit 126 via the exposed surfaces of the porous and/or fibrous medium 128. The captured water in the hygroscopic liquid is transferred to the surfaces of the electrodes 124, 130 via diffusion That absorbed water then undergoes water electrolysis in each electrolyser 120, 120A. Here the solar panel 110 generates an electrical current which is applied to the hygroscopic liquid within the water harvesting unit 126 between the cathode electrode 124 and anode electrode 130. The current provides the required bias between the electrodes 124, 130 to achieve efficient water splitting reactions, with the oxygen reduction reaction (ORR) at the anode electrode 130, and the hydrogen evolution reaction (HER) at the cathode electrode 124. The produced gases (hydrogen 150 and oxygen 152) are collected separately as a pure gas, since both electrodes 124, 130 are configured to be isolated from air. In some embodiments, any excess hygroscopic liquid can be stored between an endplate (232 in FIGS. 1E and 1F) and the porous and/or fibrous medium 128 such that when the volume of the ionic solution changes due to a relative humidity difference, the ionic solution does not overflow from the DAE module and/or the foam can continuously be wetted by the hygroscopic liquid.

### Scaled Up DAE Apparatus

As shown in FIG. 1D, a DAE apparatus can be constructed that includes number of electrolysis (hydrogen generation) modules 120 a number of hydrogen generation modules to scale up hydrogen production to a desired production rate. In the illustrated embodiment, five electrolysis modules 120 are stacked and connected in parallel to scale up hydrogen production. Again, the apparatus 200 is powered by a solar panel 110 comprising a consumed silica solar panel which runs in an open environment with high Faradaic efficiency of over 95%. The negative terminal 112 of the solar panel 110 is connected to the cathode current collector 122 of each electrolysis modules 120 via distribution cable 112A and the positive terminal 114 connected to the anode current collector 132 of each electrolysis modules 120 via distribution cable 114A to enable a current to pass through the hygroscopic electrolyte held therebetween.

The apparatus 200 comprises a framework structure 214 having an upper plate 216 on which the solar panel 110 is mounted, and five intermediary platforms or shelves 218 on which each electrolysis module 120 is mounted. The framework 214 also includes a base plate 210 which includes four pivoting type wheels 212 which enable the apparatus to be easily moved/transported into a suitable position.

FIGS. 1E and 1F show an exploded view of an electrolysis module 120 or 120A that can be included in the apparatus 200 shown in FIG. 1D. Each electrolysis module 120 comprises a tightly stacked layer structure which is formed between a top plate 230 and end plate 232 and as noted above having a cathode current collector 122, cathode electrode 124, a water harvesting unit 126 comprising a fibrous and porous medium 126 containing the hygroscopic electrolyte, an anode electrode 130 and an anode current collector 132. The water harvesting unit 126 is sandwiched between two middle plates—a cathode side mid-plate 236 and an anode side mid-plate 234 which hold the stacked layers of the fibrous and porous medium 126 (as described above) together. The top plate 230, end plate 232, and middle plates 234, 236 can be formed of any suitable material that is not reactive with the electrolyte. In some embodiments, this may be Acrylic glass (Poly (methyl methacrylate) (PMMA)). Though other materials such as Teflon or other polymers or metals could be used depending on the electrolyte. Each current collector 122 and 132 also has a flexible seal positioned on either side to assist fluid sealing of the electrolysis module 120, 120A. Four threaded elongate connectors 240 extend through the corners of each layer and are clamped together about the top plate 230 and end plate 232 to sandwich the stacked layer structure together. If required, further elongate fasteners (not illustrated) can be used to fix and seal the stacked layer structure together.

Hydrogen produced by electrolysis in each electrolysis module 120, 120A is separated from the hygroscopic electrolyte proximate the cathode electrode 124 and the oxygen produced by electrolysis is separated from the hygroscopic electrolyte proximate the anode electrode 126. As shown in FIGS. 1E and 1F, each electrolysis module 120, 120A includes a hydrogen product conduit 220 extending from the top plate 230 which is fluidly connected proximate the cathode electrode 124 through which the produced hydrogen flows out from each electrolysis module 120, 120A. The hydrogen product from each electrolysis module 120 may be further processed, for example scrubbed of oxygen and/or water to produce a desired product purity.

The electrolysis module 120A shown in FIG. 1F is also configured to collect the produced oxygen. Each electrolysis module 120A therefore also includes an oxygen product conduit 250 fluidly connected at or proximate the anode electrode 130 through which the produced oxygen flows out from each electrolysis module 120A. In this case, the conduit 250 has an end which is positioned above the anode electrode 130 to collect the produced oxygen.

As demonstrated in the following examples, each electrolysis module 120 can generate high purity hydrogen continuously under a wide range of R.H. (20% to 80%). That solar-driven prototype was operated in an open atmospheric environment and produced an average hydrogen generation rate of 0.15 ml cm⁻²electrode min⁻¹ under intense sunlight. The H₂ Faradaic efficiency was around 95.8%, and after checking the product in a gas chromatography (G.C.), the gas generated was pure hydrogen. Also, the faradaic efficiency at the anode is over 91.1%, and pure oxygen is proved as the gas production. The reaction in each module 120 can be confirmed as a water splitting reaction overall, as also demonstrated in the following examples.

The proposed DAE process and apparatus provides a new direction for future pure hydrogen production driven by sustainable energy. It is technically viable with low maintenance, structurally stable, and easy to scale up. The whole-cell does not need any extra cost for hydrogen generation, and it is economically feasible with around 90 L m⁻²catalyst h⁻¹ under strong solar energy.

### EXAMPLES

### Example 1—Hygroscopic Liquid

A limited number of hygroscopic ionic solutions can be used to absorb water vapour under low relative humidity (<20%), including KOH, NaOH, LiCl, CH₃COOK and H₂SO₄. Although KOH has the advantages of high conductivity and low capital cost, it presented with challenges. It can react with the atmosphere's carbon dioxide, producing K₂CO₃, even KHCO₃, which cannot absorb water vapour for R.H.<20%. For LiCl, a high concentration LiCl solution will cause a side reaction at the anode, generating Cl₂. However, among the investigated electrolytes, H₂SO₄ can absorb water vapour from a low R.H. environment with high conductivity. Hence, H₂SO₄ features a promising electrolyte for each DAE module.

Several hygroscopic materials were tested in a proof of concept DAE apparatus 200 and comprising electrolysis modules 120, 120A illustrated in FIGS. 1D, 1E and 1F, the details of which are set out in more detail in Example 2 below. The hygroscopic materials were tested included KOH, CH₃COOK, KOH, and H₂SO₄, representing a salt, a base, and an acid, respectively. All three materials spontaneously absorb moisture from the air and form ionic electrolytes. It was found that the direct air electrolysis modules using the respective electrolytes were able to produce hydrogen gases successfully for an extended period with a continual supply of air and power.

The hydrogen evolution performance of the DAE module with KOH started to decline after 72 hr and stopped at 96 hr. It was observed that the voltage of the DAE module increased from 2.30 V to 2.40 V due to the gradual conversion of KOH into K₂CO₃ and eventually KHCO₃ at exposure to CO₂ in the air. KHCO₃ is less soluble in water hence less conductive as an electrolyte, and critically it is non-deliquescent.

For CH₃COOK used in the DAE module, the voltage was as high as 3.70 V due to the large size of acetate anions and substantial CO₂ and ethane by-products found along with O₂ at the anode (see FIG. 1J). Substantial carbon dioxide (1.515 min), ethane (1.756 min), hydrogen (3.589 min) and methane (4.584 min) were observed with oxygen (3.780 min). CH₃COOK is therefore not the suitable choice for hygroscopic liquid in the DAE module.

A DAE module using Ni electrodes and KOH electrolyte with moisture supplied by 60% R.H. air achieved a high current density of 273 mA cm⁻² at 3.0 V and 574 mA cm⁻² at 4.0 V (See FIG. 1H). However, the performance of this DAE module started to decline after 72 hr and the experiment was stopped at 96 hr. This was because the voltage of the DAE module increased from 2.3 V to 2.4 V due to the gradual conversion of KOH into K₂CO₃ and eventually KHCO₃ at exposure to the 420 ppm level CO₂ in the air.

KHCO₃ is less soluble in water hence less conductive as an electrolyte, and critically it is non-deliquescent, unable to absorb moisture from the air. The inventors considers that if the CO₂ in the feed air can be rejected by a barrier, KOH would stay as a top choice for the DAE module.

Sulfuric acid was identified as one of the best hygroscopic materials that can absorb moisture from the air down to relative humidity 5% or below. Meanwhile, the sulfuric acid solutions are high in conductivity (0.61 S cm⁻¹ at 50.0 wt %), non-volatile, and it is non-toxic to the environment. It was found the current density of the DAE using H₂SO₄ soaked melamine sponge could also reach 150 mA cm⁻², 2.5 times higher than that using sintered glass foam, because the series resistance of the former was 50% lower owning to its high open-pore fraction (refer to FIG. 1I). However, a melamine sponge gradually degrades in the H₂SO₄ solution after a week.

For subsequent DAE trials, a sulfuric acid electrolyte was used equipped with glass foam (glass foams) and platinum (Pt) mesh electrodes (FIG. 2B) for long term stability and CO₂ resistance. It is also interesting to note that in the concentration range of sulfuric acid of this work, the corresponding freezing point of the electrolyte is below −30° C., implying potential working temperature under an icing environment.

### Example 2—Proof of Concept DAE Apparatus

The performance of a proof of concept DAE apparatus 200 and comprising electrolysis modules 120, 120A illustrated in FIGS. 1D, 1E and 1F was investigated using current density (J) and voltage (V) characteristic experiments conducted at 25° C. The effect of relative humidity ranging from 20% to 80%, as well as the pore size and thickness of the sintered glass foams, were also studied. Sintered glass foams were labelled as G1, G2 and G3 corresponding to the pore size of 50-70, 30-50, 16-30 μm, respectively. Finally, a series of experiments with extended time durations of 288 hours was also conducted to investigate the stability of the DAE module.

### Materials and Apparatus

A proof of concept DAE apparatus 100 including five DAE electrolyser modules 120, 120A was constructed as shown in FIGS. 1D, 1E and 1F.

The hygroscopic electrolyte selected for use in each DAE module was 55.0 wt % H₂SO₄ (formulated with 98% sulfuric acid and R.O. water). This electrolyte was tested under 40% R.H. and 25° C. in the climate test chamber for 12 days under constant current density 15.0 mA cm⁻².

Pt mesh (FIG. 2B) was selected as the best choice for electrodes due to such high concentration H₂SO₄ used in the experiment. Due to the dehydration and oxidation characteristics of high concentration of sulfuric acid, most of the commercially used foam, including polyurethane (PU) foam, polyvinyl alcohol (PVA) foam and melamine sponge (MS), would be hydrolysed.

The Pt mesh electrodes (as illustrated in FIG. 2B—99.99% purity, made by 0.12 mm Pt wire, while the frame was 0.5 mm Pt wire, Yueci Technology Co.) or Ni Foam electrodes (1.6 mm thickness, Keshenghe metal materials co.) were configured with geometric area 4 cm² were attached directly to the quartz wool (99.95% purity, 5-10 μm, Xinhu co.), and then connected with the sintered glass surfaces, with geometric area 7.84 cm² (Shundao sintered glass foam co.). The melamine sponge (Daiso industries co. ltd.) could replace the glass foam and the quartz wool, with the geometric area 7.84 cm².

As set out in Example 1, sulfuric acid was identified as the top choice of hygroscopic materials for use in the DAE modules. The H₂SO₄ hygroscopic electrolyte was housed in a stacked arrangement of quartz wool and sintered glass foam as illustrated in FIG. 2A. As previously noted, three different sintered glass foams were used, designated G1, G2 and G3 corresponding to the pore size of 50-70, 30-50, 16-30 μm, respectively. SEM images showing the morphology of each glass foam G1, G2 and G3 is shown in FIG. 2C. The sintered glass foams' thickness was 3 mm, and quartz wool was layered between two foams. For the desired 1.5 cm total thickness, three foams and four layers of quartz wool were used stacked as shown in FIG. 2A (b).

Teflon plate with Pt wireline (99.99% purity, Xudong Co. Ltd.) were used as current feeders and electrolyte distributors.

### Experiment 1—Stability Test

After assembly, a single DAE electrolyser module (as shown in FIG. 1E) was put inside a climate test chamber (DHT-100-40-P-SD, Shanghai Doaho Co. Ltd.), keeping a close environment at a constant R.H. and temperature. The DAE module connected directly with a DC power supply (Wanptek DPS3010U), which could supply constant current for electrolysis. The cathode's output gas production was bubbled through a water bath, and collected in an inverted, liquid-filled cylinder.

Another DC power supply (Nice Power R-SPS605D) was used to connect with the DAE module or foam-free electrolyser to collect the current density vs. voltage (JV) performance curve. The foam-free electrolyser was a 50 ml volume two-electrode cell, with a 1.5 cm electrode distance. The current was measured after 30 seconds under each voltage, using an applied voltage from 1.80 V to 3.00 V (H₂SO₄) or 1.00 V to 4.00 V (KOH) with a 100 mV increase per 30 second. The area of the electrode was 4 cm². Under each R.H., the J-V behaviour was tested before putting into the environment oven and after operating over 24 hours and 48 hours. Each J-V behaviour was verified by repeated measurements three times, with the current density variation controlled within 5-10%.

Under each R.H., the DAE module was operated under constant current density, and the weight needed to be checked each 4 hours until it reached and maintains stability over an 8 hour period. The electrolyte equilibrium concentration was calculated by the weight changes of the DAE module before operation and after steady state.

Electrochemical impedance spectroscopy (EIS) measurements were employed at 0 V vs (OCP) from 106 Hz to 10-1 Hz with an AC voltage of 10 mV for collecting the series resistance (Corrtest CS350 Electrochemical Workstation).

The gas product flowed into a measuring cylinder (25.0 mL) through a rubber pipeline for volume measurement by a collection of gases in an inverted, water-filled cylinder over water. Gas collected inside the cylinder was drawn out by the syringe and then pushed into the gas chromatography (GC) system (7890B, Agilent technologies) with a thermal conductivity detector (TCD) for analyzation. The separation columns used in the GC were HP-INNOWAx, HP-PLOT U and CP-Molsieve 5 Å Columns. The Faradaic efficiencies n_{f,H}_{₂} and n_{f,O}_{₂} were compared to the gas production with the ideal production rate.

### Experiment 2—Open Air Demonstration with Solar Panel

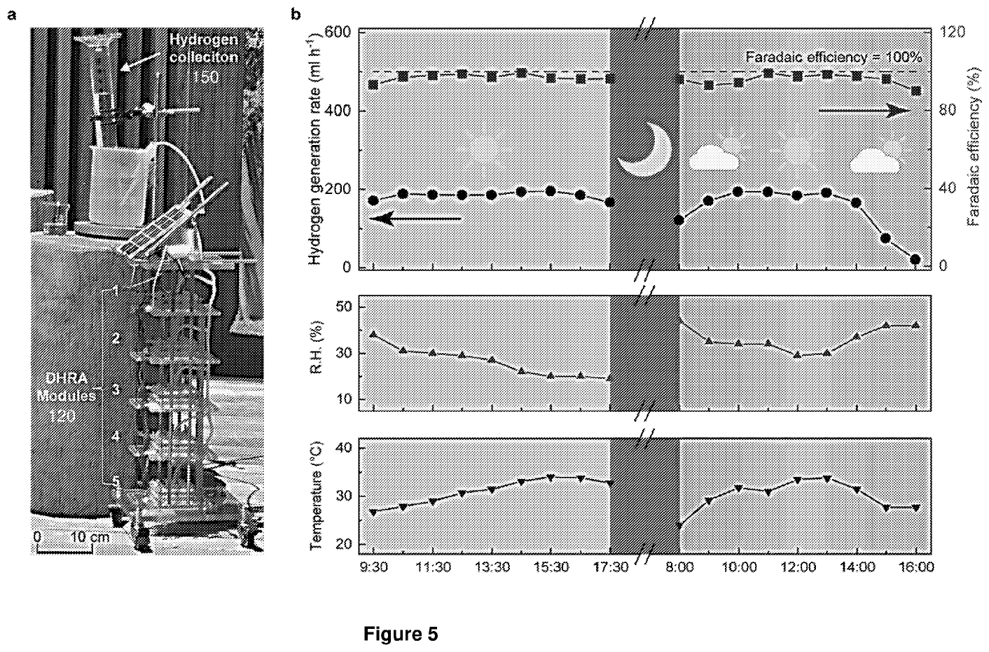

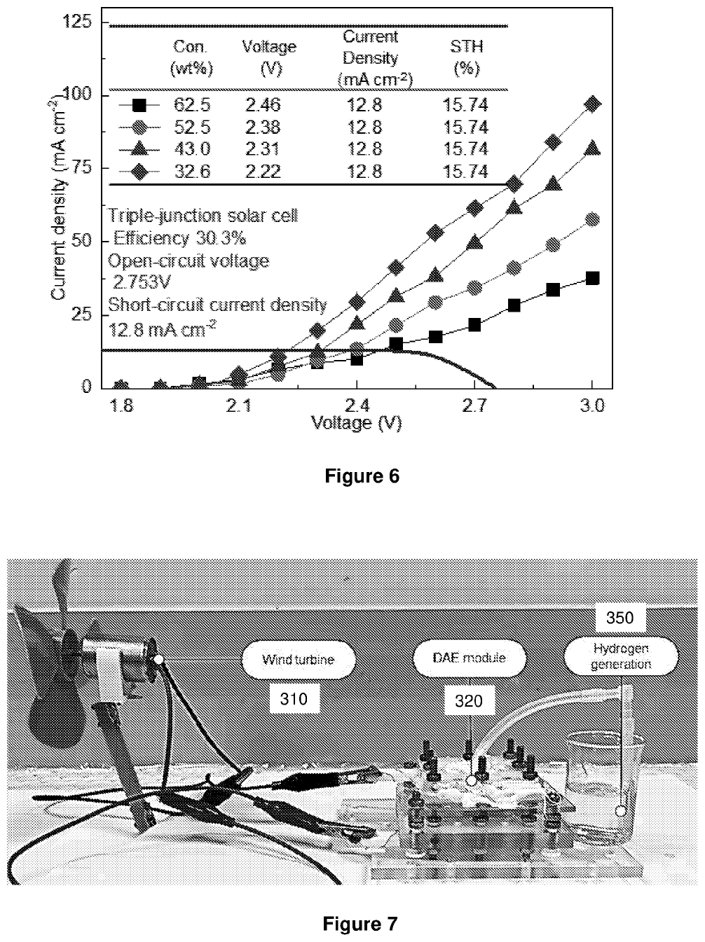

A hydrogen generation apparatus 200 was constructed using five DAE modules (hydrogen generation units) arranged in a vertically stacked framework 214 and connected in parallel as illustrated in FIGS. 1D and 5a and previously described above in relation to FIGS. 1D, 1E and 1F. Each of the DAE modules 120, 120A were vertically spaced apart on the supporting framework 214, with the hydrogen gas collected in hydrogen product conduits 220 as previously described. The product oxygen could also be collected in product conduits 250 when using the DAE modules 120A illustrated in FIG. 1E. The apparatus 200 used a commercial silicon solar panel connected in series located on top of the framework 214, angled over the upper plate 216 and had an open-circuit voltage of around 6.0 V and a short circuit current around 400 mA under Melbourne's natural sunlight. The gas product (hydrogen and oxygen) was collected and flowed into a measuring cylinder after bubbling the gas through water (as best shown in FIG. 5a) by collecting gases in an inverted, water-filled cylinder over water.

### Experiment 3—Open Air Demonstration with Wind Turbine

Here, a commercial small wind turbine was coupled with a single DAE module, with an open-circuit voltage of around 8.0 V. However, short circuit current was very low (<1 mA). The gas product was collected in an inverted, oil-filled cylinder over oil.

### Results-Stability Test

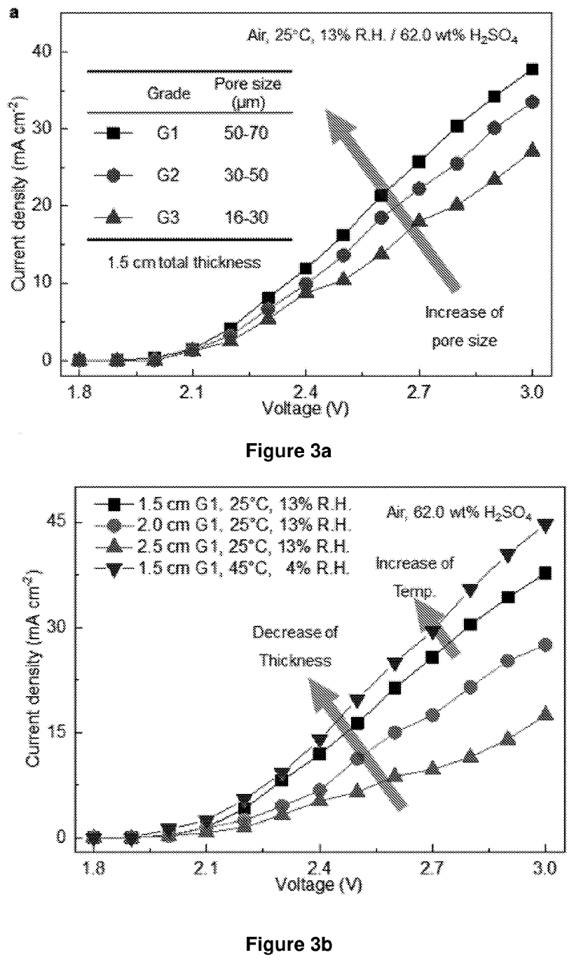

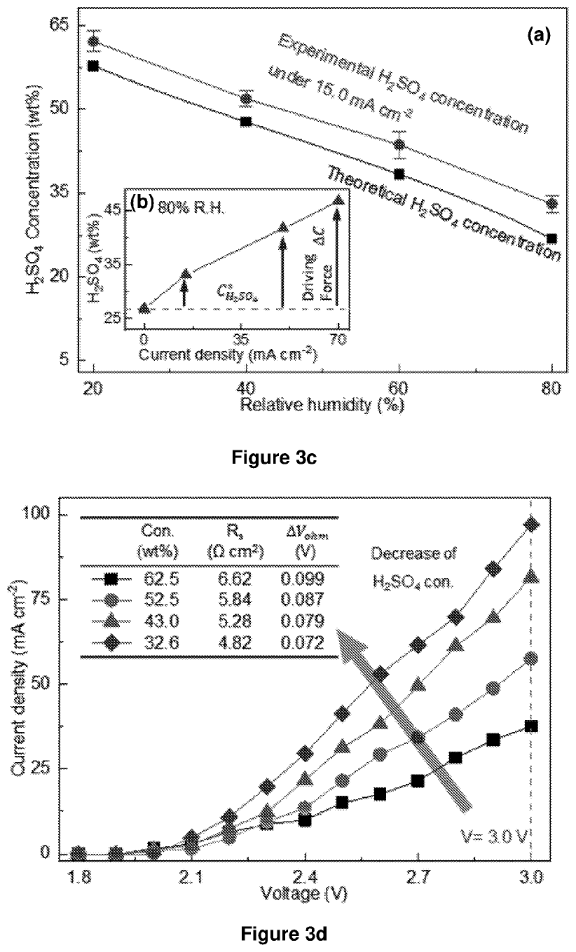

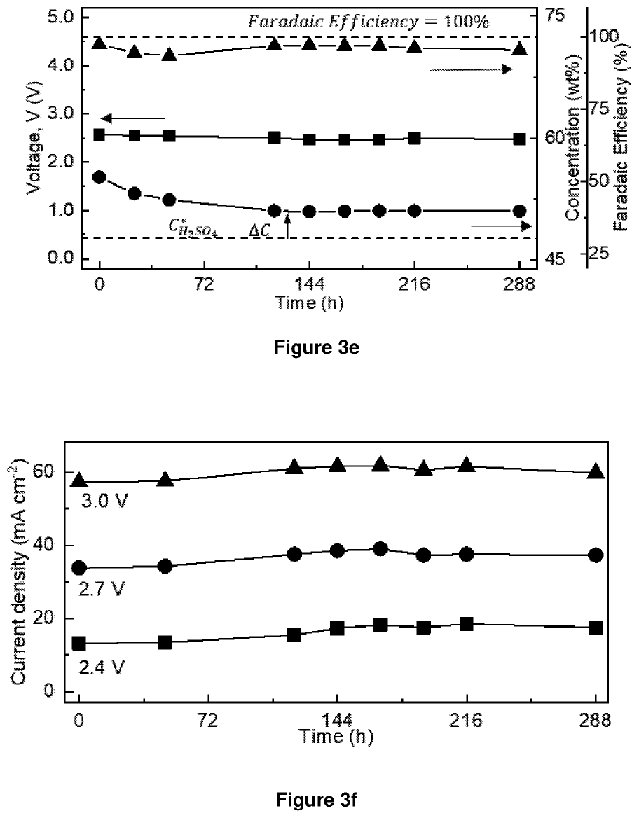

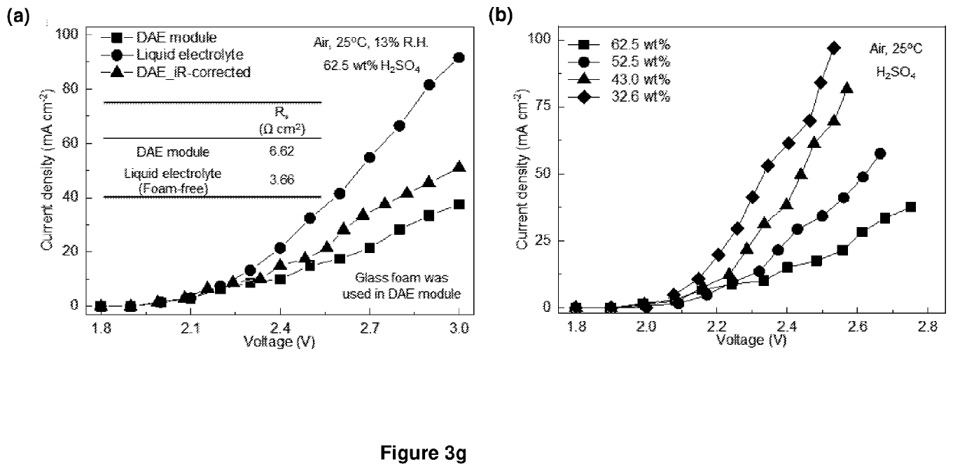

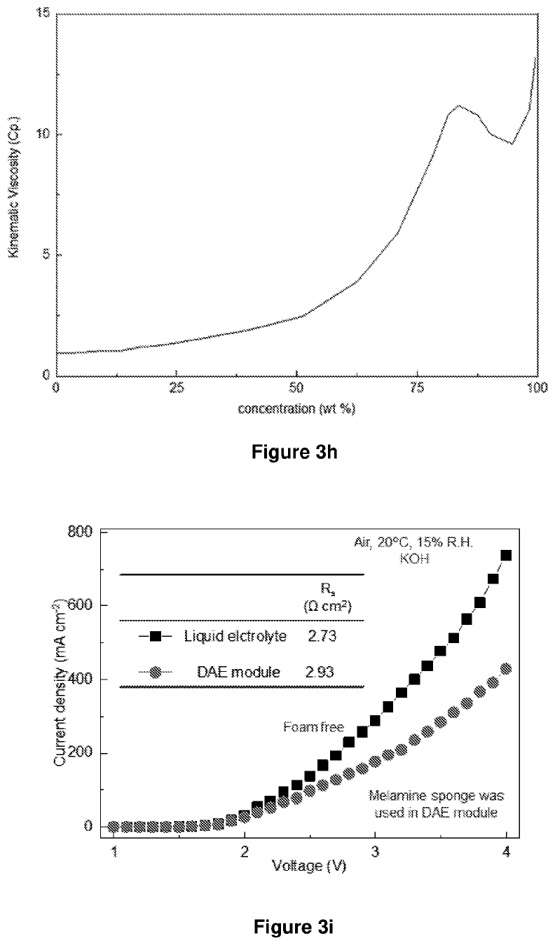

FIG. 3a shows the effect of the different pore sizes of sintered glass foam (glass foams) on the J-V behaviour using 62.0 wt % H₂SO₄ solution as electrolytes. Current density was negligible (<1 mA cm⁻²) at a voltage below 2.0 V due to the overpotential of the Pt mesh. As long as the capillary force still holds the electrolyte, the current density increases with the use of larger pored sintered glass foams pore, indicating higher conductivity and energy efficiency for overall water splitting due to better mobility of electrolyte in larger pores of the sintered glass foam. At 3.0 V, a current density of 27.1 mA cm⁻² is achieved using G3 sintered glass foam and it increased to 37.8 mA cm⁻² using G1 sintered glass foam. Therefore, the G1 sintered glass foam was chosen for further study of the foam thickness, owning to the high electrical conductivity, low resistance, and high energy efficiency it brings to the DAE module.

The operation temperature and sintered glass foam's thickness also plays a role in the J-V behaviour. As shown in FIG. 3b, with the increase of temperature from 25° C. to 45° C., the current density for the DAE module increased from 37.8 mA cm⁻² to 44.8 mA cm⁻², under a constant voltage of 3.0 V. This can be attributed to the improved ion conductivity of H₂SO₄ with elevating the temperature. In the meantime, the J-V curve shifts upwards with decreasing glass foam thickness at 25° C. At 3.0 V, the current densities are 17.5 and 37.8 mA cm 2 while using 2.5 and 1.5 cm thickness G1 sintered glass foams, respectively. According to Pouillet's law, the resistance is proportional to the distance between the electrodes, suggesting that a large distance between the cathode and anode contributed to high resistance for overall water splitting. Hence, under specific current density, the gap between two electrodes should be as small as possible to maintain relatively high energy efficiency. However, the mass transfer area for water absorption is proportional to the sintered glass foam's thickness. Therefore, it is a trade-off between the water absorption area and conductivity. Considering both factors, we chose the G1 sintered glass foam with 1.5 cm total thickness for further investigation, given that it could provide sufficient mass transfer area for air-electrolyte contact while maintaining moderate energy efficiency.

The observed experimental concentration of sulfuric acid C is constantly above its equilibrium concentration C* during the direct air electrolysis process. This difference represents the driving force for the mass transfer of water from the vapor phase into electrolyte solution and then onto the electrochemical reaction sites at the electrodes. The observed experimental concentration of sulfuric acid C is constantly above its equilibrium concentration C* during the direct air electrolysis process. This difference represents the driving force for the mass transfer of water from the vapor phase into electrolyte solution and then onto the electrochemical reaction sites at the electrodes. FIG. 3c shows that at J=15.0 mA cm⁻², the experimental concentration in the DAE module is approximately 5 wt % higher than the equilibrium at steady state, which means a stable in-situ H₂SO₄ concentration over 8 hours under a constant current density, where the rate of water absorption from air equals the rate of water consumption by electrolysis. Likewise, such steady-state mass transfer driving force can be established at fixed air relative humidity. As shown in FIG. 3c inset (b), the driving force increases proportionally with the increase of current density, which means the rate of water absorbed by the DAE module rises when the water electrolysis rate is turned up. For instance, at R.H.=80%, if a minimal current density is applied, the sulfuric acid concentration in the module is close to the equilibrium C*_{H2SO4}=26.8 wt %, and the mass transfer driving force of water absorption is nearly zero. If the current density J is increased to 70 mA cm⁻², the steady-state concentration of sulfuric acid is increased to 46.7 wt %, 75% higher than the equilibrium one C*_{H2SO4}=26.8 wt %. Therefore, the experimental DAE module is intrinsically self-converged, compatible with a broad range of air humidity and current density.

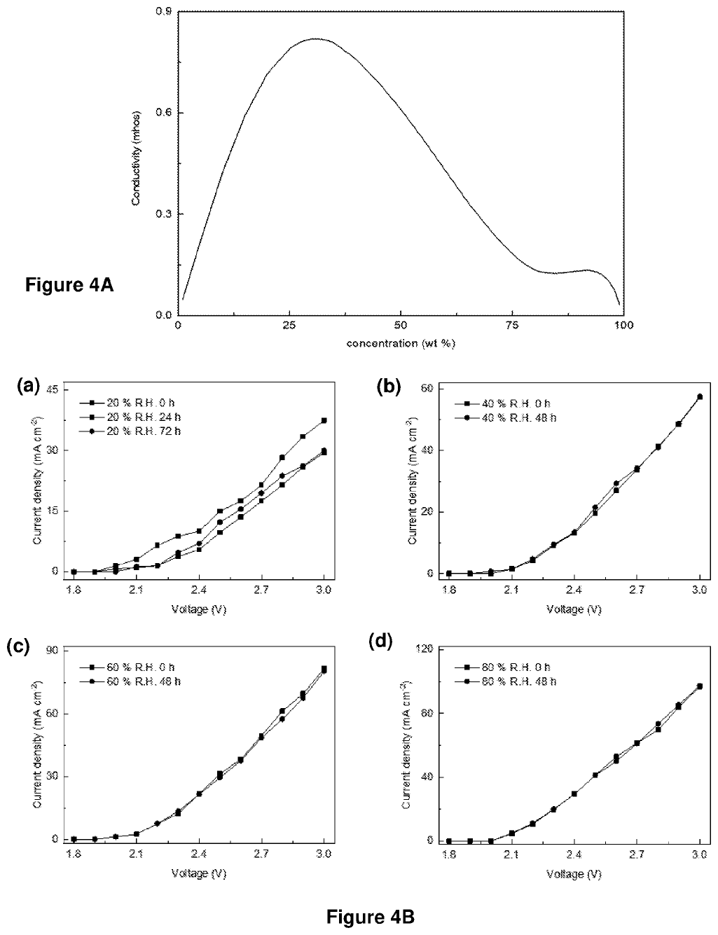

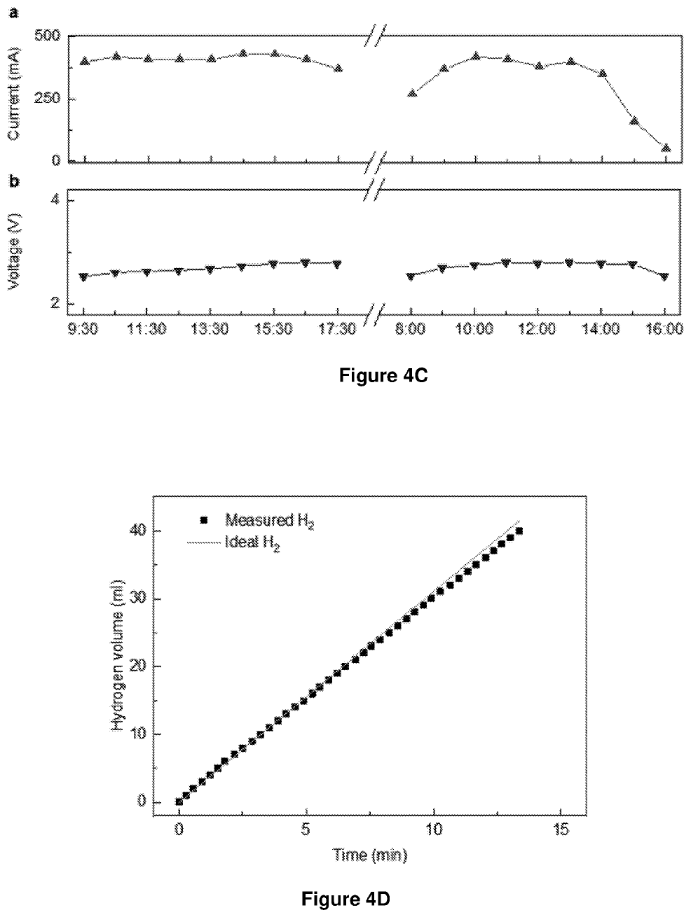

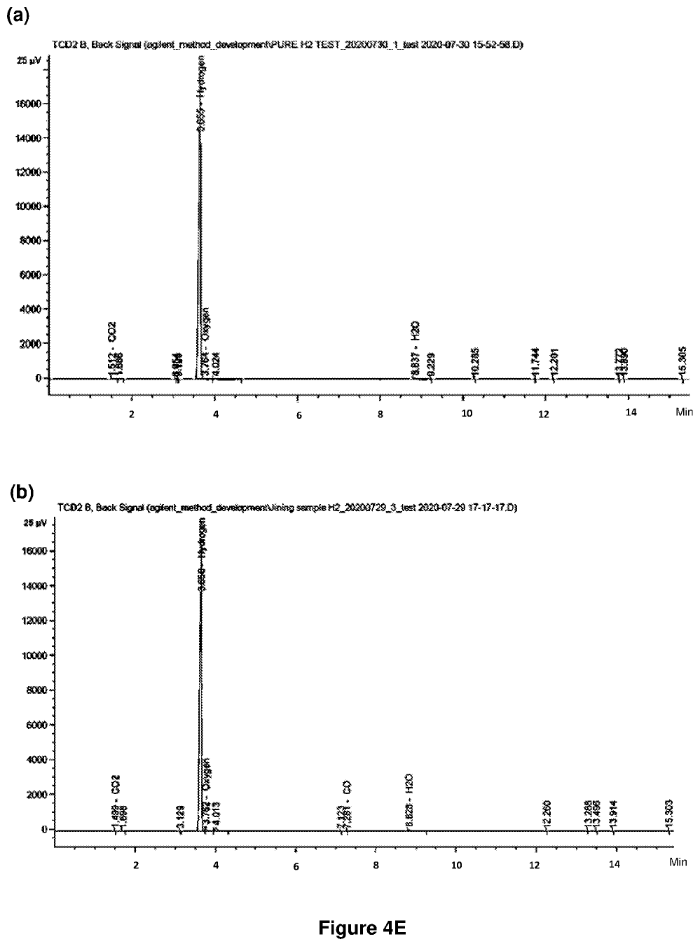

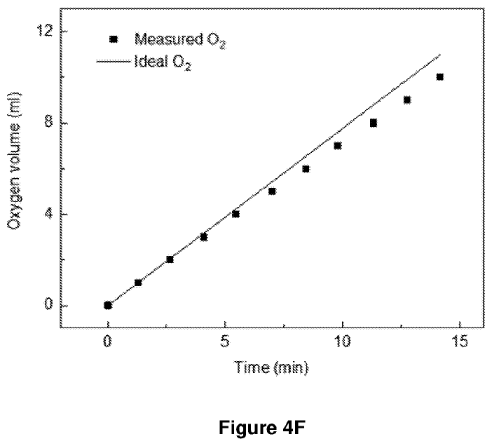

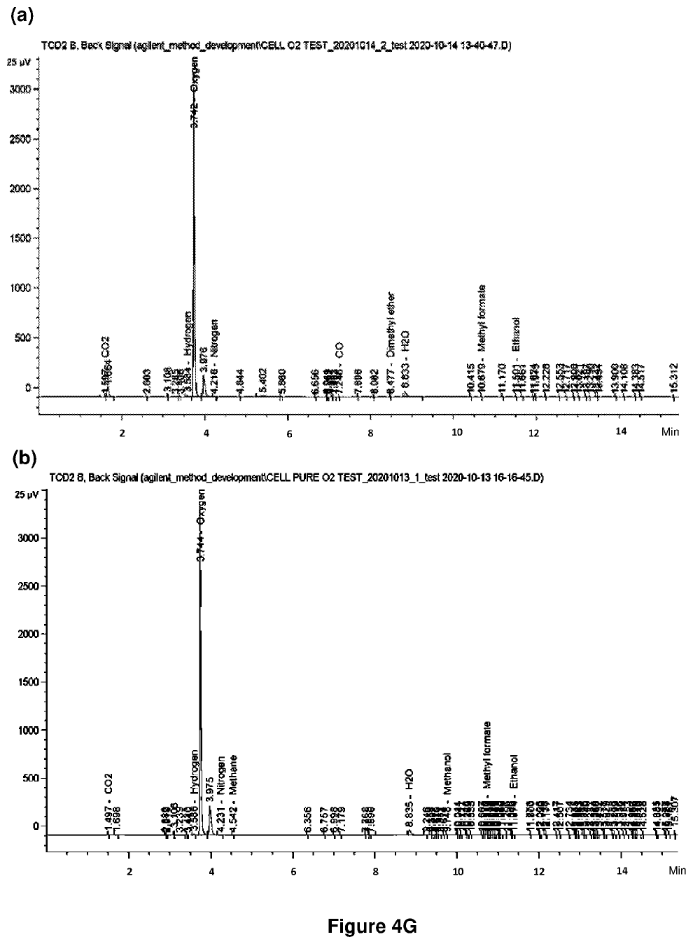

The DAE module's J-V behaviour was also studied under different H₂SO₄ concentrations (FIG. 3d). With the decrease of H₂SO₄ concentration from 62.5 wt % to 32.6 wt %, the series resistance of the system decreases from 6.62 Ωcm² to 4.82 Ωcm², while the current density for the electrolysis reaction increases significantly from 37.5 mA cm⁻² to 97.0 mA cm⁻², under a constant voltage of 3.0 V (the iR-corrected J-V curve is shown in FIG. 3g). Such change can be attributed to the improved electrical conductivity of diluted H₂SO₄ (FIG. 4A). Also, the viscosity of the electrolyte decreases as the acid is being diluted (FIG. 3h), resulting in higher electrocatalytic activity and reduced electrochemical polarization. It is worth to compare the DAE using H₂SO₄@sintered glass with that of KOH@melamine sponge, the latter has a system series resistance of 2.93 Ωcm², only 0.20 Ωcm² higher than an electrolyser using direct KOH solution i.e. foam free electrolyser (FIG. 3i). Such a low series resistance is responsible for the high current density of 574 mA cm⁻² achieved by the DAE module using KOH@melamine sponge at 4V as mentioned earlier.

The DAE module was found stable during continual electrolysis. Performance of the electrolysis cell at various voltage, energy efficiency, and air R.H. are shown in Table 1 below and FIG. 4B.

TABLE 1
Effects of R.H. on stable voltage, energy efficiency,
STH efficiency and ohmic loss (ΔVₒₕₘ) under constant
current density 15.0 mA cm⁻² for 48 hours.

| R.H. | Voltage | Energy efficiency | STH efficiency |
|---|---|---|---|
| (%) | (V) | (%) | (%) |
| 20 | 2.81 | 43.8 | 20.6 |
| 40 | 2.53 | 48.6 | 22.9 |
| 60 | 2.40 | 51.3 | 24.2 |
| 80 | 2.33 | 52.8 | 24.9 |

After a minor fluctuation initially, the J-V behaviour stabilize for a 48 hr run. For further laboratory test, we chose 40% R.H. air as the gas atmosphere condition. As shown in FIG. 3e, the concentration of H₂SO₄ fed to the module was 55.0 wt % initially, and it converged to 51.1 wt % over the first 120 hr. In the following 168 hr, the electrolyte concentration, the DAE module's voltage, the mass transfer driving force for moisture absorption (ΔC=Cₑₓₚ [51.1 wt %]−C* [47.7 wt %]=3.4 wt %) and the H₂ Faradaic efficiency (around 95%) are all stabilized. Accordingly, the DAE module's voltage drops from 2.56 V to 2.49 V. Thereafter, the dynamic equilibrium of water uptake and electrolysis is reached and both H₂SO₄ concentration and voltage remain stable.

FIG. 3f shows the current densities collected from the J-V behaviour under specific voltages (2.4, 2.7, 3.0 V) for 288 hours. All current densities shift upward in the first 120 hours, and then kept stable (reached steady state) in the following hours. This result indicates excellent adaptability and long-term stability for the DAE modules operating at different R.H., cell voltage, and electrolyte concentrations.

Results—Open Environment Measurements with Solar Cell

To further demonstrate the DAE module's working capability in a practical environment, the DAE tower was designed and tested for two days in the open air of a hot-dry summer (Mediterranean climate) on campus at the University of Melbourne, Melbourne, Australia for 8 hours each day, using a commercial solar panel as the power supply. FIGS. 1D and 5a show the details of the hydrogen generation tower. As described previously, the tower used five DAE modules 120, 120A vertically stacked. A solar panel with an open-circuit voltage of around 6.0 V and a short circuit current around 400 mA under Melbourne's natural sunlight powered the DAE tower. The temperature varied from 20° C. to 40° C., and the relative humidity ranged from 20% to 40% over the testing period. Since the solar panel was used as a renewable energy source, the voltage and current for each DAE module were solely determined by solar intensity. The product hydrogen gas evolved from the cathode was collected in an inverted, liquid-filled cylinder, which was then used to examine the gas production rate. The oxygen generated on the anode of each DAE module was vented into the air.

FIG. 5b and FIG. 4C show the hydrogen generation rate, hydrogen evolution faradaic efficiency (n_{f,H}_{₂}), the overall current and voltage during the test. The hydrogen generation's faradaic efficiency was at an average of 95% for all operating hours, shown as the line with square markers (FIG. 5b). The faradic efficiency and gas production were firstly checked in the lab, instead the solar panel with the power supply and a constant current 400.0 mA, which is similar as the solar panel (FIGS. 4D and 4E). The H₂ Faradaic efficiency is around 95.8%, and after checking the product in a gas chromatography (G.C.), the gas generated is pure hydrogen. On the first day, when the weather was sunny during the operating hours, the stable current outputs are at around 400 mA and voltage 2.68 V. The hydrogen flow rate was about 186 ml h⁻¹, with the total hydrogen production at 1490 ml, which is equivalent to 745 L H₂ day⁻¹ m⁻² of the cathode, or 3.7 m³ H₂ day⁻¹ (m² tower)⁻¹. On the second day, a few hours of good sunlight at noon (12 pm) guaranteed the current output stable at around 400 mA for 5 hours (9:00 to 13:00), with an average hydrogen generation rate of about 179 ml h⁻¹, which is similar to the H₂ generation rate on the first day. However, from 8:00 to 9:00, the solar power intensity was limited due to weather variations. Hence, the current output was lower, increasing from 270 mA to 370 mA in the first hour, with an average hydrogen generation of 140 ml h⁻¹. The weather turned cloudy in the late afternoon (14:00 to 16:00), leading to a lower photovoltaic power potential. The solar panel's current output was as low as 50 mA at 16:00, with the hydrogen generation rate dropping to 21 ml h⁻¹. On the whole, under non-ideal weather condition, the total hydrogen production could still reach 1188 ml.

The gas product collected from the cathode was analysed with gas chromatography (GC.), suggesting pure hydrogen (>99%) (FIG. 4E). The gas production from the anode was also measured using the apparatus 120A shown in FIG. 1F where the anode gas is collected through anode gas conduit 250. The faradaic efficiency at the anode is over 91.0%, and pure oxygen is proved as the gas production (FIGS. 4F and 4G). Since the Faradaic efficiency of both H₂ and O₂ measured and calculated by energy and mass balances are comparable, we again confirm the overall electrolysis is a water-splitting process. After keeping the above DAE module unattended in air for 8 months, the Faradaic efficiency of hydrogen remain around 90%, without any maintenance.

To the best of the inventor's knowledge, the DAE of the present invention appears to be the first technology exceeding the target of 20% solar-to-hydrogen (STH) energy efficiency set by the U.S. Department of Energy (DOE). DAE coupled with the triple-junction solar panel can achieve a theoretical STH efficiency of 15.7% under different H₂SO₄ concentration (FIG. 7), while coupling with the best performing solar panel using H₂SO₄ and KOH hygroscopic electrolyte can achieve a theoretical STH efficiency of 24.9% and 32%, respectively (see for example Table 1 above).

Table 2 provides the results of tests on the effects of relative humidity on stable voltage under constant current density 15.0 mA cm⁻² for 48 hours.

TABLE 2
The Effects of R.H. on stable voltage under constant
current density 15.0 mA cm⁻² for 48 hours.

| R.H. (%) | Voltage (V) |
|---|---|
| 20 | 2.81 |
| 40 | 2.53 |
| 60 | 2.40 |
| 80 | 2.33 |

The voltage used at J=15.0 mA cm⁻² was 2.81 V under R.H.=20%, and the dynamic concentration of sulfuric acid is over 60.0 wt %, which leads to a very low conductivity and energy efficiency (43.8%). Given these results, other super-hygroscopic solutions with high conductivity, a suitable low resistance porous and/o fibrous medium to house the hygroscopic solutions, and HER catalysts with low overpotential may useful improvements to the investigated apparatus and DAE module, especially at lower R.H. conditions.

### Example 3—Wind Turbine Power

Finally, it should be understood that the energy supply to the DAE module of the present invention is not limited to solar. In a demonstration example with an apparatus set up illustrated in FIG. 7, a single test DAE module 320 configured similar to the DAE modules described in relation to Example 2 was coupled with a wind turbine 310 and successfully produced high purity hydrogen 350 from the air feed.

### CONCLUSION

A new integrated cell for hydrogen production from the air was tested that can generate high purity hydrogen continuously under a wide range of R.H., as low as 4%. The apparatus was shown to work stably and produce high purity hydrogen with a Faradaic efficiency around 95% for more than 12 consecutive days under 40% R.H., without any input of liquid water. A solar-driven prototype with five parallel electrolyzers was shown to work in the open air, achieving an average hydrogen generation rate of 745 L H₂ day⁻¹ m⁻² cathode; and a wind-driven prototype has also been demonstrated for H₂ production from the air.

Compared with pre-existing conceptual frameworks' performance, the DAE can collect high purity hydrogen, while all others are limited to 5% H₂ in the end product. The minimum operating R.H. of DAE is lower than all which are limited to over 60% R.H. for durability test. Also, the incident light on the solar panel is the only energy input into the system, while the previous research for vapour-fed electrolysers needs additional energy inputs, including the energy required to pump inert gas into the electrolysers, separate mixed gas and heat water sometimes.

This new DAE electrolyser module and apparatus is a proof-of-concept for high purity hydrogen production and collection by water electrolysis without consuming freshwater and extra processing cost. In this configuration, the only energy input into the system is the renewable energy (i.e. light incident on the solar panel in this study). The module provides a new direction for future pure hydrogen production driven by sustainable energy. It is technically viable with low maintenance, structurally stable, and easy to scale up. The whole-cell does not need any extra cost for hydrogen generation, and it is economically feasible with around 90 L m⁻²_{catalyst} h⁻¹ under solar energy. The concept creates a new market for green hydrogen generation.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A process of producing hydrogen from air comprising:
contacting a hygroscopic liquid with a source of air to absorb a water content from said source of air into the hygroscopic liquid; and
electrolytically converting the water absorbed in the hygroscopic liquid into hydrogen and oxygen.

2. The process according to claim 1, wherein the hygroscopic liquid comprises an ionic liquid or a hygroscopic ionic solution.

3. The process according to claim 1, wherein the hygroscopic liquid is selected from at least one of potassium hydroxide, potassium acetate, potassium formate, sulfuric acid, lithium chloride, sodium hydroxide, isopropyl alcohol or triethylene glycol, and optionally wherein the hygroscopic ionic liquid comprises aqueous sulfuric acid having a concentration of at least 30 wt %, preferably at least 50 wt %, and more preferably at least 60 wt %.

4. (canceled)

5. The process according to claim 1, wherein the step of contacting the hygroscopic liquid with the source of air occurs in a separate process unit to the electrolytically converting step.

6. The process according to claim 1, wherein the step of contacting the hygroscopic liquid with the source of air occurs in the same process unit to the electrolytically converting step.

7. The process according to claim 1, wherein the hygroscopic liquid is contained in a porous and/or fibrous medium, and optionally wherein the porous and/or fibrous medium comprises at least one of a porous glass, or crystalline fiber medium, preferably at least one of a sintered glass foam or quartz wool, preferably a combination of sintered glass foam or quartz wool which contain the hygroscopic liquid therein, more preferably at least one sintered glass foam located between two separate layers of quartz wool.

8-12. (canceled)

13. The process according to claim 1, wherein the hygroscopic liquid comprises:
an electrolyte for electrolysis in the at least one electrolyser; or
a mixture of the hygroscopic liquid with an ionic solute to form the electrolyte for electrolysis in the at least one electrolyser.

14. The process according to claim 1, wherein the step of converting the water comprises:
applying an electrical current between spaced apart cathode and anode electrodes and through the hygroscopic liquid which is housed therebetween,
and optionally wherein the electrical current is provided by a renewable electricity source, preferably at least one solar cell,
and optionally, wherein the electrical current is applied between each cathode and anode with a current density of at least 10 mA cm⁻², preferably at least 15.0 mA cm⁻², and preferably is applied between each cathode and anode with a voltage of at least 2 V, preferably between 2 and 6 V.

15-17. (canceled)

18. The process according to claim 1, wherein the cathode includes a hydrogen evolution reaction catalyst, and optionally wherein the cathode includes and preferably comprises a platinum electrode.

19. (canceled)

20. The process according to claim 1, further comprising the step of collecting the produced hydrogen at or proximate the cathode electrode in a hydrogen product stream.

21. The process according to claim 1, further comprising the step of collecting the produced oxygen at or proximate the anode electrode in an oxygen product stream.

22. The process according to claim 1, wherein the source of air comprises atmospheric air, and optionally the source of air has a relative humidity of between 4 and 100%, preferably between 4 and 80%, more preferably between 20 and 80%.

23. (canceled)

24. An apparatus for producing hydrogen from air comprising:
at least one absorber containing a hygroscopic liquid, the absorber being configured to contact the hygroscopic liquid with a source of air to absorb a water content from said source of air into the hygroscopic liquid; and
at least one electrolyser configured to electrolytically convert the water absorbed in the hygroscopic liquid into hydrogen and oxygen.

25. The apparatus according to claim 24, wherein the hygroscopic liquid comprises an ionic liquid or a hygroscopic ionic solution.

26. The apparatus according to claim 24, wherein the hygroscopic liquid is selected from at least one of potassium hydroxide, potassium acetate, potassium formate, sulfuric acid, lithium chloride, sodium hydroxide, isopropyl alcohol or triethylene glycol, and optionally wherein the hygroscopic ionic liquid comprises aqueous sulfuric acid having a concentration of at least 30 wt %, preferably at least 50 wt %, and more preferably at least 60 wt %.

27. (canceled)

28. An apparatus according to claim 24, wherein the hygroscopic liquid comprises:
an electrolyte for electrolysis in the electrolytically converting step; or
a mixture of the hygroscopic liquid with an ionic solute to form the electrolyte for electrolysis in the electrolytically converting step.

29. The apparatus according to claim 24, wherein the hygroscopic liquid is contained in the absorber in a porous and/or fibrous medium, and optionally wherein the porous and/or fibrous medium comprises at least one of a porous glass, or crystalline fiber medium, preferably at least one of a sintered glass foam or quartz wool, preferably a combination of sintered glass foam or quartz wool which contain the hygroscopic liquid therein, more preferably at least one sintered glass foam located between two separate layers of quartz wool.

30-35. (canceled)

36. The apparatus according to claim 24, wherein the at least one absorber and the at least one electrolyser are included in the same process unit, and further comprising a combined absorber and electrolyser that comprises a cathode; an anode, and the hygroscopic liquid situated between the cathode and anode which is in contact with a source of air, and optionally wherein the cathode comprises a cathode current collector and electrically connected cathode electrode, the cathode current collector being connected to a negative terminal of an electrical source, and the anode comprising an anode electrode electrically connected to an anode current collector which is connected to a negative terminal of the electrical source, and optionally wherein the anode and cathode include electrodes comprise a metallic mesh, preferably a platinum mesh electrode.

37-43. (canceled)

44. The apparatus according to claim 24, wherein the at least one electrolyser is powered by an electrical source comprising a renewable electricity source, preferably at least one solar cell, and optionally the electrical source produces a current density of at least 10 mA cm⁻², preferably at least 15.0 mA cm⁻², and optionally the electrical source applies a voltage between each cathode and anode of at least 2 V, preferably between 2 and 6 V.

45-46. (canceled)

47. The apparatus according to claim 24, wherein the source of air is atmospheric air, and optionally wherein the source of air has a relative humidity between 4 and 100%, preferably between 4 and 80%, more preferably between 20 and 80%.

48-51. (canceled)
